(19) United States
(12) Patent Application Publication
(10) Pub. No.: US 2017/0147960 A1
(43) Pub. Date: May 25, 2017

(54) Systems and Methods for Project Planning and Management

(71) Applicant: STRATEGIC DNA ADVISORS INC., d/b/a ROI ARCHITECTS, Aurora, IL (US)

(72) Inventor: Ketan R. Jahagirdar, Aurora, IL (US)

(21) Appl. No.: 15/427,562

(22) Filed: Feb. 8, 2017

Related U.S. Application Data
(63) Continuation of application No. 14/328,390, filed on Jul. 10, 2014, now abandoned.
(60) Provisional application No. 61/950,580, filed on Mar. 10, 2014.

(51) Int. Cl. G06Q 10/06

(52) U.S. Cl. CPC G06Q 10/063114; G06Q 10/063118; G06Q 10/06313

(57) ABSTRACT

A project management system manages a project by continuously monitoring each phase of the project to greatly increase the probability that all required deliverables are produced while adhering to project constraints. The project management system tracks and displays the progress being made and the current status of each deliverable in the project to enable users to easily view and understand the overall project progress along with risks and issues associated with the project in one centralized system The project management system also performs project portfolio management by evaluating individual projects based on various business valuation criteria to correlate the impact of the individual projects to the strategic goals of the business. Accordingly, the project management system provides a system enabled centralized governance framework that enables the users to efficiently plan and manage any type of project.

### RELATED APPLICATIONS

This application is a continuation of U.S. patent application Ser. No. 14/328,390, filed on Jul. 10, 2014, which claims the benefit under 35 U.S.C. §119(e) of U.S. Provisional Patent Application Ser. No. 61/950,580, entitled “Systems and Methods for Project Planning and Management,” filed Mar. 10, 2014, the entire disclosure of each of which is hereby expressly incorporated by reference herein.

### TECHNICAL FIELD

The present disclosure generally relates to a project and task management system for which any business or organization can use to plan and manage a project and/or independent tasks.

### BACKGROUND

A project may be defined as a set of tasks that must be carried out in order to produce a desired outcome, such as a unique product or a service that brings about beneficial change or added value. Project planning and management is the discipline of defining and scheduling each task in a project, allocating appropriate resources to each task, and monitoring each task to ensure that the required output of each task is produced in order to achieve the desired outcome of the project.

Project planning and management is usually the responsibility of project managers, as well as other business leaders. While project managers may not directly participate in the various tasks of a project to produce the end result, the project managers are responsible for overseeing the implementation and execution of the various tasks in a way that ensures the overall success of the project.

However, for many businesses and organizations, especially those with global or distributed footprints, planning and managing a project can be a challenging issue because project managers often make decisions based on qualitative status reports and non-standardized information that is not normalized and is derived from various sources. Due to a lack of centralized organization and oversight, project planning and management is often carried out in an ad hoc manner. To illustrate, consider an example scenario in which a worker at a manufacturing plant comes up with a great idea for a new software project to improve inventory tracking in the plant. The worker's manager documents the idea in a report and proceeds to meet with the chief information officer (CIO) who controls the resources required to implement the new project.

The manager discusses the report with the CIO and convinces the CIO of the idea for the new project. However, the CIO is also inundated with various other project reports and spreadsheets, and thus, has no easy way to ascertain how the new project would fit in relation to existing projects. Further, the CIO may not have the most up-to-date information on what tasks are being carried out by every worker on the software development team or what priorities are guiding those tasks. As a result, the CIO is forced to make certain assumptions, and may simply decide in an ad hoc manner to somehow accommodate the new project.

The CIO then asks the team lead on the software development team to work on the new project. However, because the CIO does not have all the information, the CIO cannot quickly determine the relative importance of the new project. As such, the CIO may again make certain assumptions, and decide in an ad hoc manner to de-prioritize an existing database project in order to implement the new project right away. The team lead is instructed to reallocate resources from the existing database project to start work on the new project.

Because of these ad hoc decisions, progress on the now de-prioritized database project slows. Consequently, the head of human resources, who had sponsored the database project, approaches the CIO to inquire about the situation. The head of human resources also escalates the situation to the chief executive officer who is now forced to resolve the issues created by the CIO's decision to accommodate the new project.

As the above example scenario illustrates, conflicts and problems are inevitably created when decisions about projects are improvised or made based on insufficient information. Furthermore, project and portfolio managers are frequently faced with a myriad of other day-to-day challenges during the course of planning and managing a project or projects. For example, questions are asked on how to link projects to business objectives, and how to consistently select the right projects to invest. In addition, questions are asked on how balance work that is required to keep a business alive with work that is required to grow the business. Oftentimes, however, the project managers are expected to make decisions about projects without the equivalent of an income statement or balance sheet, or make decisions based on estimates or risk analyses that have not gone through the proper iterations.

Moreover, for any type of project, questions are always asked on what work has been done and what is the performance so far. Accordingly, the project managers must ensure that their projects are carried out in a regimented manner that will deliver the tangible results on time. In this regard, the project managers are expected to properly allocate and utilize resources, understand the various constraints affecting their projects, and effectively deal with risks and issues that may arise during the course of their projects.

At the present, most project management systems or tools do not provide the level of support needed to effectively handle many of the challenges faced by project managers and other business leaders. For example, many conventional project management tools do not necessarily provide a centralized framework that integrates all aspects of a project. Further, many conventional project management tools do not collect and adequately track project-related data to provide project managers with the most up-to-date information on the project. In addition, many conventional project management tools do not adequately calculate, monitor or indicate the status of the project. For example, projected delays in the project are not properly taken into account when generating the true status of the project, due to a lack of availability of the data required to proactively calculate and indicate the impact on project status. As a result, the decision making abilities of project managers who use many of the conventional project management tools are often limited and inconsistent.

### SUMMARY

A project management system provides a means that allows any business or organization to plan and manage a project and/or independent tasks. In particular, the project management system oversees the implementation and execution of a project by continuously tracking and monitoring each task of the project to ensure that all required deliverables are produced while adhering to typical project constraints. Further, the project management system generates indications regarding the progress being made and the current status of the project. Still further, the project management system provides mechanisms to document risks and issues that may impact the outcome of the project. In addition, the project management system provides mechanisms to define and carry out plans to mitigate the risks and issues that may arise during the course of the project. The severity of the risks and issues is taken into account when the status of the project is calculate and indicated. In this manner, the project management system provides an early warning system that can notify project managers and other users of the overall project progress as well as potential setbacks that may affect the overall progress. Accordingly, the project management system offers a centralized and holistic governance framework that enables project managers and other users to efficiently plan, execute, and manage any type of project.

Moreover, the project management system performs portfolio planning management by evaluating projects and proposed projects based on a number of business valuation criteria. More particularly, the project management system assesses the importance of a project by analyzing various financial metrics associated with the project. In this manner, the project management system allows for high-level project planning and management by correlating the impact of individual projects to business objectives such as benefits, profitability, and strategic direction.

In an embodiment, a computer-implemented method for planning and managing a project comprises defining a deliverable associated with the project. The deliverable specifies an amount of work that needs to be performed to complete the project. The method also assigns a budget, a planned start date, and a planned end date for the deliverable. Further, the method allocates one or more workers to perform the amount of work on the deliverable. Still further, the method determines an available capacity for the one or more workers based on the allocation of the one or more workers. The method then receives an indication of an actual amount of work performed by the one or more workers on the deliverable, and receives an indication of an estimate to completion (ETC) for the deliverable. In addition, the method calculates an estimate at completion (EAC) for the deliverable based on summing the indication of the actual amount of work performed by the worker and the indication of the ETC for the deliverable. The method also calculates a projected end date for the deliverable based on comparing the available capacity for the one or more workers and the indication of the ETC for the deliverable. Moreover, the method calculates a status for the deliverable based on one or more of: (i) a comparison between the budget and the EAC; (ii) a comparison between the projected end date and the planned end date; (iii) the allocation of the one or more workers; (iv) number of risks and issues associated with the deliverable; or (v) severity of the risks and issues associated with the deliverable. Additionally, the method displays the status for the deliverable to a user.

In another embodiment, a non-transitory computer-readable storage medium includes computer-readable instructions that are executed on one or more processors of a system for planning and managing a project. The instructions when executed cause the one or more processors to define a deliverable associated with the project. The deliverable specifies an amount of work that needs to be performed to complete the project. The instructions when executed also cause the one or more processors to assign a budget, a planned start date, and a planned end date for the deliverable. Further, the instructions when executed cause the one or more processors to allocate one or more workers to perform the amount of work on the deliverable. Still further, the instructions when executed cause the one or more processors to determine an available capacity for the one or more workers based on the allocation of the one or more workers. The instructions when executed then receive an indication of an actual amount of work performed by the one or more workers on the deliverable, and receive an indication of an estimate to completion (ETC) for the deliverable. In addition, the instructions when executed cause the one or more processors to calculate an estimate at completion (EAC) for the deliverable based on summing the indication of the actual amount of work performed by the worker and the indication of the ETC for the deliverable. The instructions when executed also cause the one or more processors to calculate a projected end date for the deliverable based on comparing the available capacity for the one or more workers and the indication of the ETC for the deliverable. Moreover, the instructions when executed cause the one or more processors to calculate a status for the deliverable based on one or more of: (i) a comparison between the budget and the EAC; (ii) a comparison between the projected end date and the planned end date; (iii) the allocation of the one or more workers; (iv) number of risks and issues associated with the deliverable; or (v) severity of the risks and issues associated with the deliverable. Additionally, the instructions when executed cause the one or more processors to display the status for the deliverable to a user.

In yet another embodiment, a project management system for planning and managing a project comprises a project management database and a project management server that includes a memory having instructions for execution on one or more processors. The instructions when executed by the one or more processors cause the project management server to define a deliverable associated with the project. The deliverable specifies an amount of work that needs to be performed to complete the project. The instructions when executed by the one or more processors also assign a budget, a planned start date, and a planned end date for the deliverable. Further, the instructions when executed by the one or more processors allocate one or more workers to perform the amount of work on the deliverable. Still further, the instructions when executed by the one or more processors determine an available capacity for the one or more workers based on the allocation of the one or more workers, receive an indication of an actual amount of work performed by the one or more workers on the deliverable, and receive an indication of an estimate to completion (ETC) for the deliverable. The instructions when executed by the one or more processors then store the received indication of the actual amount of work performed by the one or more workers and the indication of the ETC in the project management database. The instructions when executed by the one or more processors calculate an estimate at completion (EAC) for the deliverable based on summing the indication of the actual amount of work performed by the one or more workers and the indication of the ETC for the deliverable. The instructions when executed by the one or more processors also calculate a projected end date for the deliverable based on comparing the available capacity for the one or more workers and the indication of the ETC for the deliverable. Moreover, the instructions when executed by the one or more processors calculate a status for the deliverable based on one or more of: (i) a comparison between the budget and the EAC; (ii) a comparison between the projected end date and the planned end date; (iii) the allocation of the one or more workers; (iv) number of risks and issues associated with the deliverable; or (v) severity of the risks and issues associated with the deliverable. The instructions when executed by the one or more processors then store the calculated status for the deliverable in the project management database. Additionally, the instructions when executed by the one or more processors display the status for the deliverable to a user.

### BRIEF DESCRIPTION OF THE DRAWINGS

FIG. 1 is a block diagram illustrating an example web-based client-server architecture in which a project management system can operate to plan and manage a project.

FIG. 2 is a flow diagram of an example method that illustrates a project planning and management process.

FIG. 3 is a block diagram illustrating example building blocks used in creating a project and capturing the state and status of the project.

FIG. 4 is a block diagram illustrating various computer implemented components of an example project management system.

FIG. 5 is a screenshot illustrating an example workspace generated by the project management system shown in FIG. 4 to create and configure phases and deliverables of a project.

FIG. 6 is a block diagram illustrating an example project template that can be created and used by the project management system shown in FIG. 4.

FIG. 7 is a screenshot illustrating an example workspace generated by the project management system shown in FIG. 4 to view and select a project template.

FIG. 8 is a screenshot illustrating an example workspace generated by the project management system shown in FIG. 4 to define plans to deal with risks and issues.

FIG. 9 is a screenshot illustrating an example workspace generated by the project management system shown in FIG. 4 to plan, execute, monitor and manage a project including entering actual time worked against tasks and entering corresponding estimate to completion time.

FIG. 10 is a screenshot illustrating an example workspace generated by the project management system shown in FIG. 4 to review, enter, edit and submit time.

FIG. 11 is a screenshot illustrating an example workspace generated by the project management system shown in FIG. 4 to manage a “watchlist,” which is a logical group of assignments.

FIGS. 12A-12C are screenshots illustrating an example workspace generated by the project management system shown in FIG. 4 to manage and view high-level status of projects.

FIG. 13 is a screenshot illustrating an example workspace generated by the project management system shown in FIG. 4 to view and enforce a project governance flowchart.

FIG. 14 is a screenshot illustrating an example workspace generated by the project management system shown in FIG. 4 to manage a project portfolio.

### DETAILED DESCRIPTION

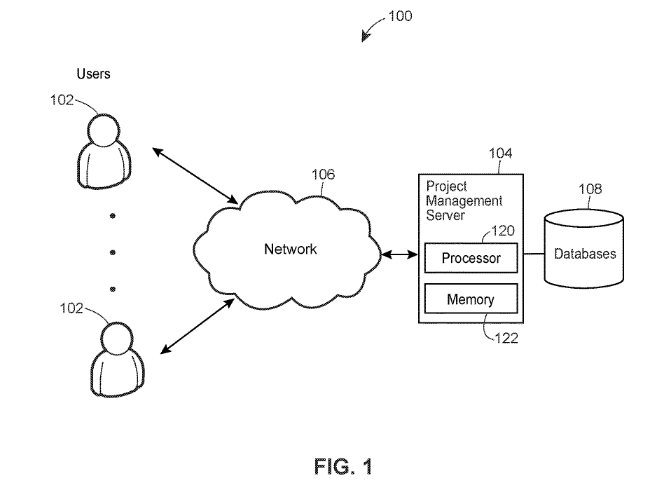

FIG. 1 illustrates an example web-based client-server architecture 100 in which a project management system can operate to plan, execute, and manage a project and/or independent tasks. The example web-based client-server architecture 100 includes one or more users 102 interacting with a project management server 104 via a communication network 106. The one or more users 102 may comprise any number of project managers, workers, administrators, etc. Each of the one or more users 102 operates a client computing device (not shown), which communicates with the project management server 104 over the network 106 to input, retrieve, and/or access information during the course of planning and managing a project. The network 106 may include any desired wired and/or wireless links (e.g., the Internet, a local area network, a wide area network, a mobile network, etc.). Further, the client computing device may be, for example, a desktop computer, a laptop computer, a personal digital assistant, a smart phone, or any other information processing device.

Generally speaking, the one or more users 102 may be part of a business or organization, such as a software company, a retailer, a non-profit organization, a governmental agency, etc. In some implementations, the one or more users 102 are located in the same geographical location, while in other implementations, the one or more users 102 are dispersed in different geographical locations. Regardless, the web-based client-server architecture 100 can be implemented in a way that serves multiple users in multiple locations and for multiple projects.

The project management server 104 can be a single server or a plurality of servers with distributed processing. As shown in FIG. 1, the server 104 is coupled to one or more databases 108. There may be one or more security devices, such as firewalls, between any of the components. For example there may be a firewall between the network 106 and the server 104. Additionally, there may be a set of firewalls between the server 104 and the one or more databases 108. In some implementations, the one or more databases 108 may not be directly coupled to the server 104, but instead may be accessible by the server 104 via a network such as the network 106. The one or more databases 108 are repositories for various data and information used by the server 104 during the course of planning and managing a project.

Generally, the project management server 104 is configured to perform various functions associated with project planning and management. To this end, a processor 120 of the server 104 may execute instructions, routines, programs or modules stored in a memory 122 of the server 104 to enable users (e.g., the one or more users 102) to perform operations such as creating new projects, strategizing and organizing projects, tracking and monitoring projects, understanding project resource utilizations, managing issues and/or risks that may arise during the course of projects, etc. In any or all of these cases, programming stored in the memory 122 and executed on the processor 120, act as or form parts of a project management system that enables the users to plan, execute, and manage projects in any of the manners described herein. Additionally, the one or more databases 108 may include database servers (not shown), which may store and execute various programming to enable the users to plan, execute and manage projects in any of the manners described herein.

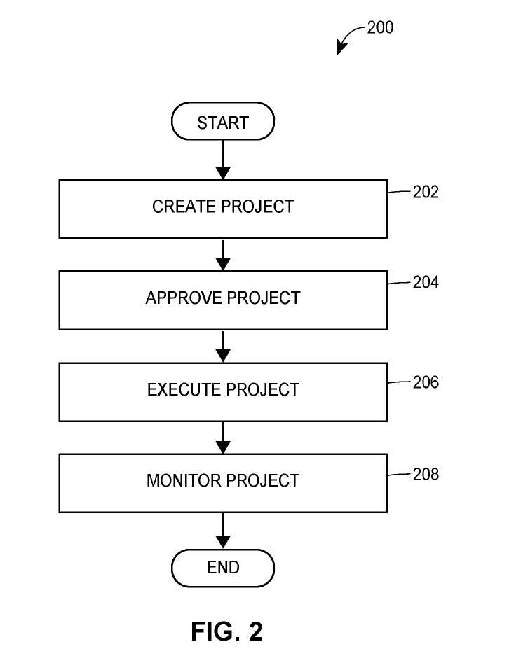

FIG. 2 depicts an example flow diagram of a method 200 that can be implemented to plan and manage a project. With reference to FIG. 1, the method 200 may be implemented by one or more computer implemented routines or programs or modules stored in the memory 122, and executed by the processor 120 of the project management server 104.

Generally speaking, FIG. 2 shows the main segments of an overall project planning and management process. At a block 202, the method 200 creates a project. Specifically, the method 200 creates a project by defining each stage or phase of the project. For example, a software project may be created by defining the various phases of the software project such as a software design phase, a software development phase, a software testing phase, etc.

After defining each project phase, the method 200 specifies one or more deliverables to be produced in each project phase. Each deliverable describes an output to be generated and/or a task to be performed in order to generate that output. For example, with reference to the above software project, one or more deliverables may be defined in the software design phase to indicate the output or outputs of the design phase (e.g., a high-level design for the software, a technical design for the software, etc.). When every deliverable in a project phase is produced, the project phase is considered complete. Accordingly, a project is considered complete when each project phase in the project is completed.

Once the project is fully created and configured, the method 200 proceeds to approve the project at a block 204. After the project is approved, the method 200 then proceeds to execute the project at a block 206. Here, the method 200 tracks the implementation and execution of the project by tracking data entered by various users (e.g., workers, project managers, administrators, etc.), as well as naturally occurring events such as elapsed days. More particularly, the method 200 records and tracks user-entered data for each deliverable in the project along with elapsed days. For example, the method 200 may record the number of hours that a worker has spent working on a deliverable and an estimate to completion (ETC) time for completing the deliverable. In some implementations, user-entered data may include the actual cost incurred on the deliverable (e.g., an amount of money spent or consumed).

Based on the user-entered data, the method 200 performs calculations to determine the progress being made on the deliverable. For example, using the actual time spent on a deliverable and the estimate to completion (ETC) time for the deliverable, the method 200 can calculate an estimate at completion (EAC) time for the deliverable (e.g., the forecasted total time for completing the deliverable). From this calculation, the method 200 can then determine a percentage of completion for the deliverable.

Further, the method 200 performs calculations to generate a current status for the deliverable. For example, the method 200 can determine the current status by comparing the calculated EAC time to the budgeted time for completing deliverable. Alternatively or additionally, the method 200 can determine the current status by computing a projected end date and comparing the projected end date to the planned end date of the deliverable. Alternatively or additionally, the method 200 can determine the current status by determining the allocation of the resources between the planned start date and end date (e.g. how much time is being allocated to workers to work on the deliverable). Alternatively or additionally, the method 200 can determine the current status by evaluating the number and severity of risks and/or issues associated with the deliverable.

At a block 208, the method 200 monitors the project by continuously overseeing the progress being made and generating the current status of each deliverable in the project. The method 200 accomplishes this in conjunction with the block 206. That is, based on the calculations in the block 206, the method 200 monitors the progress being made and generates the current status of the project one deliverable at a time. The method 200 also communicates the progress being made and the current status of the project to the users. For example, the method 200 may visually display health scores for each deliverable in the project as well as an overall project health score. The overall project health score may be calculated using a weighted average of the health scores for each deliverable in the project. In addition, the method 200 may visually display the ETC, EAC, and percentage of completion for each deliverable in a project. This allows the users to easily view and understand how much work has been done and how much work is still required to complete each deliverable in order to finish the project. By communicating the progress being made and the current status of the project, the method 200 provides an early warning system in which if the progress or current status of a deliverable indicates a potential setback, the method 200 can quickly alert the users to the situation. This in turn enables the users to make efforts to rectify the potential setback in a timely and efficient manner.

Moreover, the method 200 allows the users to define risks and issues that may arise during the course of the project. To deal with these risks and issues, the method 200 enables the users to create and associate remedial action plans with each deliverable in the project. The remedial action plans may include risk control plans, issue resolution plans, and/or action items. For example, an issue may entail delays in completing a deliverable due to unforeseen problems affecting a supplier. In order to resolve this issue, the users may create and implement an issue resolution plan (e.g., assisting the current supplier to overcome the problems, working with alternate suppliers, etc.). Accordingly, the method 200 treats the issue resolution plan in the same way as a deliverable. In other words, the method 200 tracks the implementation and execution of the issue resolution plan by recording and tracking user inputs (e.g., actual time spent working on the plan). Based on the user inputs, the method 200 then monitors the progress being made on the plan, and generates a current status for the plan to ensure that the plan can be completed successfully.

In general, the blocks 202-208 may be executed each time that a project is defined and carried out. Moreover, in various implementations, the method 200 may include additional blocks not shown in FIG. 2. For example, the method 200 may perform functions such as portfolio planning and management. In this case, the method 200 evaluates projects (or proposed projects) based on various financial metrics (e.g., cash flows, income statements, etc.). The method 200 can use this analysis to enable certain users (e.g., portfolio managers or business leaders) to approve proposed projects as well as select the appropriate projects to invest. The method 200 can also use this analysis to rank projects in terms of business impact. In doing so, the portfolio managers or business leaders can quickly review and link the value and alignment of individual projects to the objectives or goals of a business or organization. Additionally, as part of the portfolio planning and management, the method 200 can perform analysis on project resource utilization to determine how resources (e.g., workers) are being allocated and managed.

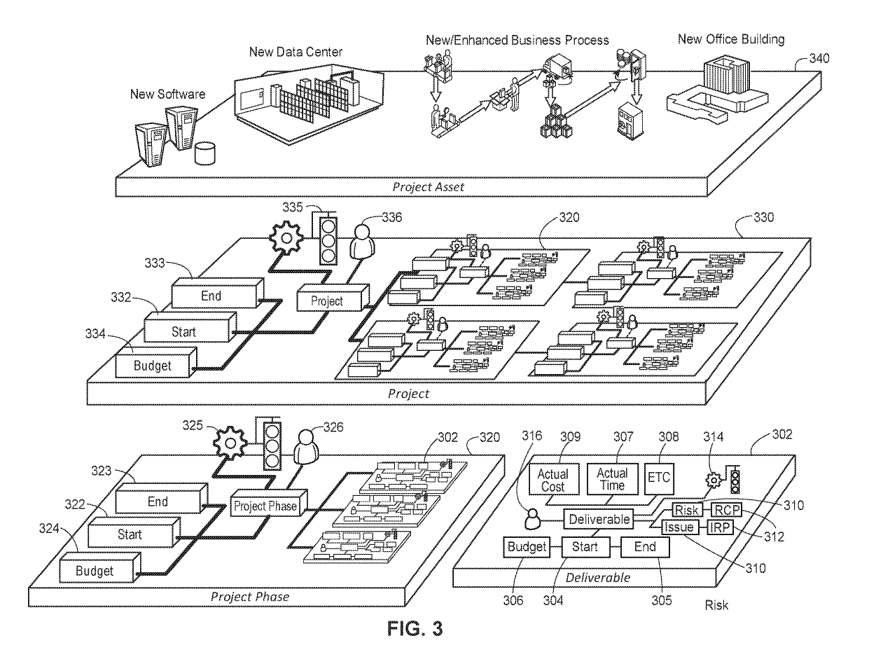

FIG. 3 depicts example building blocks used in creating a project. As such, FIG. 3 represents a unique way of looking at the individual components of the project ranging from deliverables to assets. The lowest building block shown in FIG. 3 is a deliverable block 302. Generally, the deliverable block 302 represents an output to be produced as a result of a task to be performed. Accordingly, the deliverable block 302 may be characterized by a planned start date 304, a planned end date 305, and a budget 306. Work performed on the deliverable block 302 may be characterized by an actual time spent working on the deliverable 307, an ETC time for the deliverable 308, and an actual cost incurred on the deliverable 309. Moreover, the deliverable block 302 may include definitions for risks and issues 310 that may affect the deliverable, as well as one or more mitigation plans 312 to manage and resolve those risks and issues. Further, the deliverable block 302 may include a current status indication 314, which is generated based on the actual time 307 and the ETC time 308. In some implementations, the current status indication 314 may be generated based on the actual cost 309. Still further, the deliverable block 302 may include a resource allocation indication 316, which specifies which resources and how the resources (e.g., workers) are allocated for the deliverable.

The next level of building block shown in FIG. 3 is a project phase block 320. The project phase block 320 may comprise one or more deliverables blocks 302. The project phase block 320 can also be characterized by a planned start date 322, a planned end date 323, and a budget 324. Further, the project phase block 320 may include a current status indication 325 and a resource allocation indication 326. Combining multiple project phase blocks 320 results in a project block 330. Similar to the other blocks, the project block 330 can be characterized by a planned start date 332, a planned end date 333, a budget 334, a current status indication 335, and a resource allocation indication 336. The highest level of building block shown in FIG. 3 is a project asset block 340, which is generated as a result of completing the project block 330. The project asset block 340 represents the desired final outcome, such as a unique product (e.g., a new software, a new office building, etc.), or a service that brings about beneficial change or added value (e.g., a new business process).

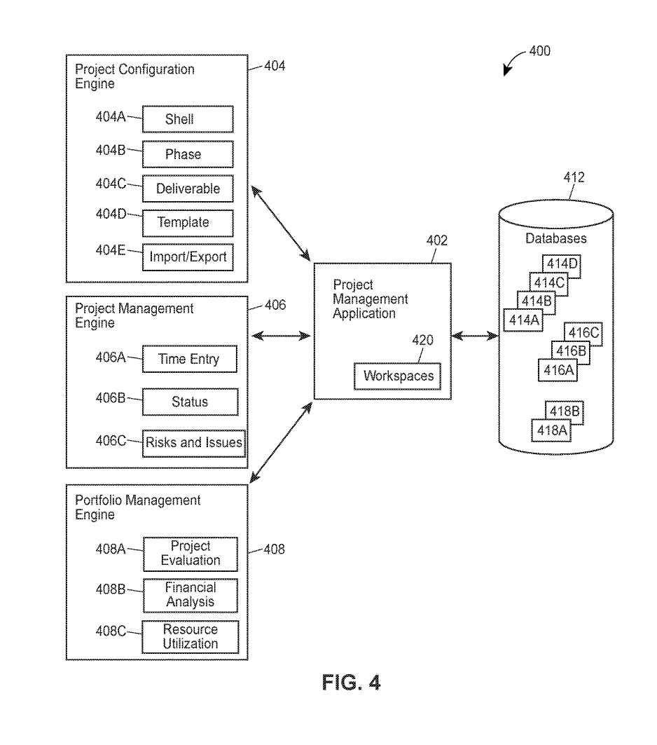

FIG. 4 illustrates various computer implemented components of an example project management system 400. As shown in FIG. 4, the project management system 400 includes a project management application 402 and a plurality of modules or engines 404-408. With reference to FIG. 1, the application 402 and the engines 404-408 may be stored in the memory 122, and executed by the processor 120 of the project management server 104. The project management system 400 also includes a database 412, which may be similar to the one or more databases 108 in FIG. 1.

The database 412 includes data and information necessary for performing the functions of the project management system 400, including project creation, project execution, project monitoring, project resource utilization, portfolio planning and management, etc. As such, the database 412 includes data used to create or configure a project such as project phase data 414A, project deliverable data 4148, project template data 414C, and external template data 414D. Further, the database 412 includes data used to execute and monitor a project such as project time data 416A, project status data 4168, and risks and issues data 416C. Still further, the database 412 includes data used to perform project portfolio planning and management such as project evaluation data 418A and project resource data 418B. While FIG. 4 shows the data 414, 416 and 418 as stored together in the database 412, in some scenarios, each of the data 414, 416 and 418 may be stored separately in different databases all accessible by the project management application 402.

The project management application 402 controls the storage, organization, and retrieval of data from the database 412. As such, the application 402 may process requests from users to enter, retrieve, and/or access various data and information during the course of planning and managing a project. To facilitate these user interactions, the application 402 includes one or more workspaces 420. The project management application 402 may also control the security and integrity of the database 412 in order to prevent unauthorized users from viewing or updating certain portions of the database 412.

Generally speaking, users can interact with the project management application 402, via the workspaces 420, to create new projects. To perform this function, the application 402 executes a project configuration engine 404, which includes a shell module 404A, a phase module 404B, a deliverable module 404C, a template module 404D, and an import/export module 404E.

In some scenarios, creating a new project involves defining or creating the project from scratch, that is without the use of any pre-defined project template. As such, the project configuration engine 404 executes the shell module 404A, which creates a project shell with basic information such as but not limited to a project name, a project sponsor, a project description, a desire or requested budget, a project start date, a project end date, etc. Next, the project configuration engine 404 executes the phase module 404B and retrieves the project phase data 414A from the database 412 to create or edit each stage or phase of the project. The project phase data 414A specifies information needed to configure a project phase from scratch. In an example implementation, the phase module 404B may process the project phase data 414A, and configure each project phase to include a name, a description, a start date, an end date, and a budget. The phase module 404B may also configure each project phase to include one or more milestones, each of which represents a measurement of progress toward the end result. For example, a milestone may be placed at the end of each project phase to indicate the completion of each project phase. When all the project phases have been defined or created, the phase module 404B assembles the project phases together to form a complete project. In the final project phase, the end result may be specified to indicate the desired asset (e.g., a new software, a new office building, an enhanced business process, etc.) that will be produced by completing the project.

The project configuration engine 404 can also execute the deliverable module 404C and retrieve the project deliverable data 4148 from the database 412 to create one or more deliverables for each project phase. The project deliverable data 4148 specifies information needed to configure a deliverable from scratch. A deliverable describes an output that needs to be generated and/or a task that needs to be performed in order to generate that output. A deliverable operates as the fundamental unit in a project, whereby the project is considered complete when each and every deliverable in the project is successfully produced or completed. In an example implementation, the deliverable module 404C may process the project deliverable data 4148, and configure each deliverable in a project to include a name, a description, a start date, an end date, a budget, and an output format (e.g., a document, a software code, etc.). Multiple deliverables may be linked in a sequence where the completion of one deliverable entails the prior completion of other deliverables. A project is considered fully configured from scratch when all the necessary project phases and deliverables are defined or created. A fully configured project may be archived and stored in the database 412, for example.

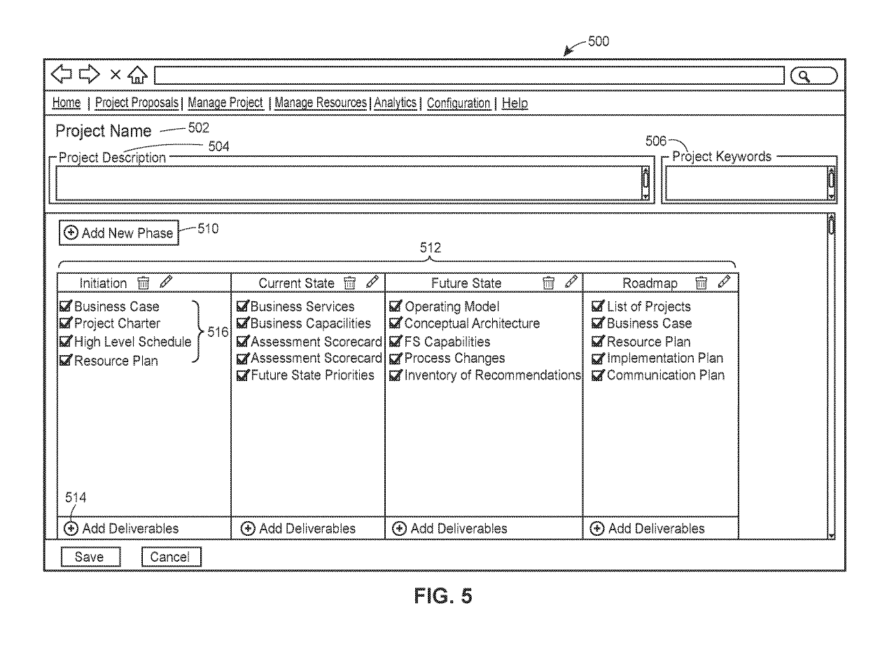

FIG. 5 illustrates a screenshot of an example workspace 500, which can be used to facilitate the process of creating a new project. With reference to FIG. 4, the workspace 500 may be generated by the project configuration engine 404 and stored as part of the workspaces 420. A user can interact with the workspace 500 to define and configure a project from scratch by specifying a project name 502, a project description 504, and one or more project keywords 506. The user can also execute a button 510 to create or add a project phase to the project. For example, FIG. 5 shows various newly created project phases 512. For each of the project phases 512, the user can create or add one or more deliverables 516 by executing a button 514.

Returning to FIG. 4, in some scenarios, creating a new project involves using pre-defined project templates. As such, the project configuration engine 404 executes the template module 404D and retrieves the project template data 414C from the database 412 to create the project from existing pre-defined templates. The project template data 414C specifies information on standard (e.g., out of the box) and customized project templates, as well as standard and customized phase and deliverable templates. The standard project, phase, and deliverable templates are defined for various standard project types (e.g., home construction projects, software development projects, etc.), while the customized project, phase, and deliverable templates are created using various user-defined templates. In addition, each project template may include a set of recommended project phases and deliverables (e.g., a set of recommended phase and deliverable templates). Thus, a new project can be created and configured quickly by simply selecting and duplicating an existing project template.

Furthermore, projects that are created from project templates can be tweaked to fit the users' needs or preferences. For example, if desired, any of the recommended project phases and/or deliverables can be deleted, edited or modified. Alternatively or additionally, new project phases and/or deliverables may be added. This can be accomplished by either creating project phases and/or deliverables from scratch, or by selecting from a master list of standard and customized phase and/or deliverable templates. In some implementations, creating a new project involves selecting and assembling various phase and/or deliverable templates from the master list.

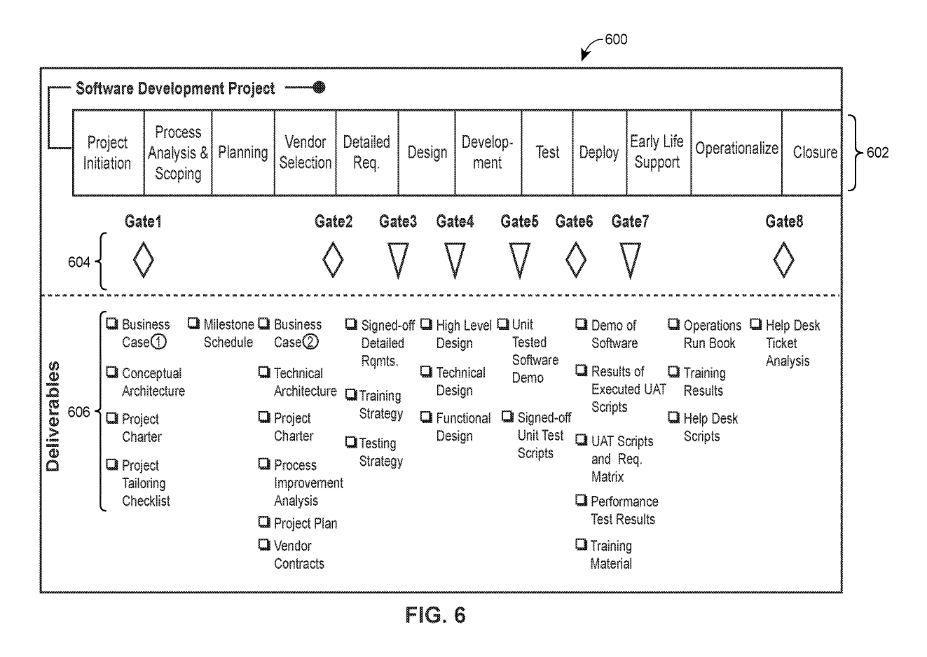

FIG. 6 shows an example project template 600, which describes a software development project. With reference to FIG. 4, the project template 600 may be stored as part of the template data 414C in the database 412. The configuration engine 404 may process the project template 600 to create and configure a new project. As shown in FIG. 6, the project template 600 includes various project phases 602, and various gates or milestones 604 and deliverables 606 associated with the project phases 602.

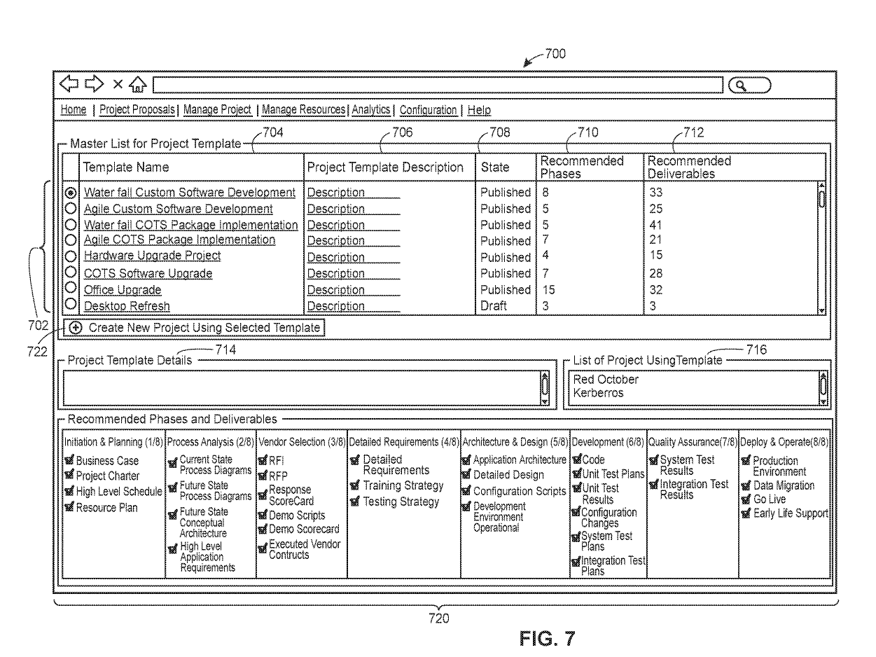

FIG. 7 illustrates a screenshot of an example workspace 700, which can be used to facilitate the process of viewing and selecting project templates. With reference to FIG. 4, the workspace 700 may be generated by the project configuration engine 404 and stored as part of the workspaces 420. A user can interact with the workspace 700 to view and select a project template from a master list of project templates 702. As shown in FIG. 7, the master list 702 outlines the names of each project template in a template name column 704, the description of each project template in a template description column 706, the state of each project template (e.g., whether the project template is published or still a draft) in a state column 708, and the number of recommended phases and deliverables for each project template in a recommended phase column 710 and a recommended deliverable column 712, respectively. When the user clicks on or otherwise selects a particular project template, the workspace 700 also displays the description of the selected project template in detail in a description box 714. Further, the workspace 700 displays a box 716 which shows a list of existing projects that have been created based the selected project template. Still further, the workspace 700 shows details of the recommended phases and deliverables associated with the selected project template in columns 720. If desired, the user may execute a button 722 to add or create a new project based on the selected project template.

Referring back to FIG. 4, in some scenarios, creating a new project and/or a project template involves importing external project templates or plans generated by external or third-party software applications (e.g., a spreadsheet application such as Microsoft Excel or Microsoft Project). As such, the project configuration engine 404 executes the import/export module 404E and retrieves the external template data 414D in the database 412 to create the project from external project templates. Once retrieved, the import/export module 404E can process, convert and configure the external template data 414D for further use by the project configuration engine 404 or other modules and applications in the project management system 400. Alternatively or additionally, the import/export module 404E may retrieve external project templates from other external databases via a network connection, such as the network 106 in FIG. 1. The import/export module 404E can also export project templates (stored as part of the template data 414C in the database 412) for use by other external software applications. For example, the import/export module 404E can export a list of project templates and associated details, or details of a specific project template. If desired, the import/export module 404E can convert the exported project templates into a suitable format for viewing, and/or for processing by the other external software applications.

Generally speaking, users can also interact with the application 402, via the workspaces 420, to execute and monitor projects. To perform this function, the application 402 executes a project management engine 406, which includes a time entry module 406A, a status module 406B, and a risks and issues module 406C.

Executing and monitoring a project generally involves tracking data entered by the users regarding work performed on the project. In an implementation, the users can enter the actual time spent working on a project (e.g., the number of hours spent to produce a deliverable in the project). As such, the project management engine 406 executes the time entry module 406A to receive data entered by the users such as the number of actual working hours and the ETC time for completing the deliverable. Generally, indications of work performed on a deliverable (e.g., the number of actual working hours) cannot be entered by the users unless a corresponding ETC time is also entered.

Moreover, the time entry module 406A may receive other time-related data entered by the users such as the budgeted time, the planned start date, and the planned end date or due date for the deliverable. All of these user-entered data may be stored as part of the project time data 416A in the database 412. The time entry module 406A can continuously accept and store user-entered data on a regular basis (e.g., daily, weekly, etc.).

Various users (e.g., workers, project managers, administrators, etc.) can log time on a project by submitting time spent working on one or more of the deliverables in the project. Normally, a worker is assigned to work on specific deliverables in a project. However, time submitted by the worker must be approved by the project manager overseeing the project. The project management engine 406 can execute the time entry module 406A to allow the project manager to review, approve or reject time submitted by the worker. This functionality ensures that every worker is properly working on his or her assigned deliverables. If a worker submits time for a deliverable that he or she is not assigned to, but nevertheless worked on (e.g., provided subject matter expertise, reviewed documents, etc.), the worker may attach an explanation message along with the submitted time to request approval from the project manager in charge. Further, a worker assigned to a project can add new deliverables to the project. To accomplish this, the time entry module 406A may invoke either the deliverable module 404B to enable the worker to create a new deliverable from scratch, or the template module 404C to enable the worker to select or configure an appropriate deliverable template. When the worker adds a new deliverable to the project, the time entry module 406A may notify the project manager in charge, or if necessary, seek approval from the project manager. Still further, when multiple workers log time on a deliverable, the time entry module 406A keeps track of the time submitted by each worker, and if desired, can display the submitted time associated with each worker. This enables the project managers to quickly determine what work has been done and the workers responsible for the work.

Once time has been logged for a deliverable, the project management engine 406 executes the status module 406B to determine the progress being made on the deliverable. In particular, the status module 406B retrieves the project time data 416A in the database 412 to access the user-entered actual working time and the ETC time for the deliverable. Based on the actual working time and the ETC time, the status module 406B calculates the EAC time for the deliverable. Specifically, the EAC time is calculated by summing the actual working time and the ETC time. Using the computed EAC time, the status module 406B can calculate the percentage of completion for the deliverable to determine the progress being made on the deliverable. Specifically, the percentage of completion is calculated by dividing the actual working time by the EAC time. The calculated percentage of completion for the deliverable may be stored as part of the project status data 4168 in the database 412, for example.

In generally, the status module 406B may communicate any or all of the information specified in the project time data 416A and/or the project status data 4168 to the users. For example, the status module 406B may visually display the actual working time, the ETC time, the EAC time, and the percentage of completion for the deliverable as bar graphs. The status module 406B may continuously update the bar graphs as new information is entered and processed (e.g., as new working time is logged by the users).

Aside from determining the progress being made on the deliverable, the project management engine 406 executes the status module 406B to determine the current status of the deliverable. In doing so, the status module 406B provides an early warning system to notify, remind or make the users aware of any potential setbacks that may affect the deliverable. For example, a setback may refer to a problem associated with an overrun on the budget, a delay or unintended extension in the duration time, or an over allocation of resources. Generally, there are three methods in which the status module 406B can determine the current status.

First of all, the status module 406B can determine the current status by comparing the computed EAC time to the budgeted time. In this scenario, the status module 406B calculates a variance or percentage difference between the EAC time and the budgeted time. For example, if the variance between the EAC time and budgeted time is between 0% and 5%, then the current status of the deliverable is determined to be acceptable or within tolerance. If the variance between the EAC time and budgeted time is between 6% and 15%, then the current status of the deliverable is determined to show a slight setback. On the other hand, if the variance between the EAC time and budgeted time is greater than 16%, then the current status of the deliverable is determined to show a severe setback. Of course, the tolerance limits on the variance can be set or adjusted as needed.

Secondly, the status module 406B can determine the current status by comparing a projected end date to the planned end date for completing the deliverable. To illustrate how the projected end date is calculated, consider an example scenario in which two workers are assigned to work on a deliverable. The deliverable is given a budgeted time of 50 hours, and a planned end date that calls for a total number of five working days to complete the deliverable. The first worker is assigned to work full-time (e.g., 8 hours a day) on the deliverable, which entails that the first worker needs to work 40 hours (out of the budgeted 50 hours) on the deliverable. The second worker is assigned to work part-time (e.g., 2 hours a day) on the deliverable, which entails that the second worker needs to work the remaining 10 hours on the deliverable.

After the first day of work, the first worker completes 8 hours of work on the deliverable while the second worker did not work on the deliverable at all. Thus, the actual working time for the first worker is 8 hours and the ETC time for the first worker is 32 hours after the first day. For the second worker, the actual working time is 0 hours and the ETC time is still 10 hours after the first day. To determine the projected end date for the deliverable, each worker's available capacity for the remaining time until the planned end date is calculated. The available capacity is a sum of each worker's reserved capacity and each worker's free capacity. The first worker's free capacity is zero because the first worker has been assigned to work full-time on the deliverable. Thus, the available capacity for the first worker after the first day is 32 hours (e.g., reserved capacity+free capacity=(8 hours×4 remaining days)+(0 hours×4 remaining days)=32 hours).

The second worker's free capacity is determined based on the second worker's overall work schedule because the second worker has been assigned to work part-time on the deliverable. For example, if the second worker is also assigned to work part-time (e.g., 2 hours) on another assignment, then the second worker can have an extra 4 hours per day to work on the deliverable (as each worker works a total of 8 hours per day in a full-time capacity). Accordingly, the available capacity for the second worker after the first day is 24 hours (e.g., reserved capacity+free capacity=(2 hours×4 remaining days)+(4 hours×4 remaining days)=24 hours).

Each worker's available capacity for the remaining time until the planned end date is then compared to each worker's ETC time. If the available capacity is greater than or equal to the ETC time, then the projected end date does not change from the planned end date. After the first day of work, each of the first and second worker's available capacity is greater than or equal to each of the first and second worker's respective ETC time. Thus, the projected end date for the deliverable after the first day of work remains the same as the planned end date.

After the second day of work, the first worker completes 5 hours of work for a cumulative total of 13 hours spent working on the deliverable, while the second worker also completes 2 hours on the deliverable. Thus, the actual working time for the first worker is 13 hours and the ETC time for the first worker is 27 hours after the second day. For the second worker, the actual working time is 2 hours and the ETC time is 8 hours after the second day. The available capacity for the first worker after the second day now becomes 24 hours (e.g., reserved capacity+free capacity=(8 hours×3 remaining days)+(0 hours×3 remaining days)=24 hours). Similarly, the available capacity for the second worker after the second day now becomes 18 hours (e.g., reserved capacity+free capacity=(2 hours×3 remaining days)+(4 hours×3 remaining days)=18 hours).

Here, the second worker's available capacity is still greater than the second worker's ETC time, which does not affect the projected end date. However, the first worker's available capacity is now less than the first worker's ETC time. Specifically, the first worker's ETC time is greater than the first worker's available capacity by 3 hours, which affects the projected end date. In other words, the projected end date needs to be extended such that the projected end date is after the planned end date (e.g., an extra working day is added to account for the missed 3 hours). Thus, the total number of days or the duration to complete the deliverable now becomes six instead of five, which represents a 20% difference or increase between the projected end date and planned end date.

Once the projected end date is computed, the status module 406B can determine the current status of the deliverable by calculating a variance or percentage difference between the projected end date and the planned end date. Accordingly, the status module 406B can determine whether the current status of the deliverable is acceptable (e.g., 0-5%), shows a slight setback (e.g., 6-15%), or a severe setback (e.g., >16%).

Thirdly, the status module 406B can determine the current status by determining the allocation of the resources for the deliverable between the planned start date and the planned end date. Generally, the status module 406B examines how much time is being allocated to workers to work on the deliverable. Normally, a worker is assigned x hours over y days to work on a deliverable, which results in a flat line allocation of x/y hours per day. For example, a default allocation may be 8 hours per day in a 5-day working week. Thus, if the worker is assigned 40 hours over 4 days in a week (i.e., 10 hours per day) to work on the deliverable, and the default allocation is 8 hours per day, then the result is a worker allocation of 125%. Consequently, based on the calculated percentage of worker allocation, the status module 406B can determine whether the current status of the deliverable is acceptable (e.g., <100%), shows a slight setback (e.g., 100-125%), or a severe setback (e.g., >125%).

It should be noted that the status module 406B may determine the current status of the deliverable by using one or any combination of the three methods described above.

Once determined, the current status of the deliverable may be stored as part of the project status data 4168 in the database 412. To communicate the determined current status to the users, the status module 406B may generate and display a visual indication such as a current status indicator (e.g., an icon, a text label, an image, etc.). For example, the current status indicator may be color-coded such that a green color indicates that the current status of the deliverable is acceptable, an amber color indicates that the current status shows a slight setback, and a red color indicates that the current status shows a severe setback. Further, the current status of a particular deliverable may impact or affect the current status of other deliverables or tasks. For example, if the current status of a deliverable turns red to indicate a severe setback, then all other deliverables or tasks that are dependent on the deliverable should also turn red to indicate the severe setback.

In addition, the status module 406B provides a mechanism for the users to submit updates to the current status of the deliverable. That is, even though the status module 406B may determine that the current status of a deliverable shows a slight setback, a worker assigned to work on the deliverable may manually change the current status (e.g., change the current status to be acceptable). This may occur because certain deliverable parameters may have been modified or changed. For example, the planned end date of a deliverable has been intentionally extended, and thus there is more flexibility in the duration time to complete the deliverable. However, any manual changes made to the current status of the deliverable should be accompanied by comments or explanations stating the reasons as to why the changes are necessary, which helps to guard against errors and/or spurious changes.

During the course of executing and monitoring a project, the project management engine 406 also allows the users to identify and define risks and issues that may arise. Examples of risks and issues include part defects, unexpected legal or regulatory changes, estimation errors, outsourcing delays, workers joining the team late, etc. To deal with these risks and issues, the project management engine 306 executes the risks and issues module 406C to enable the users to create and associate risk control plans, issue resolution plans, and/or action items to any deliverable in a project. Once created, the risks and issues module 406C may store and archive each plan or action as part of the risk and issues data 416C in the database 412.

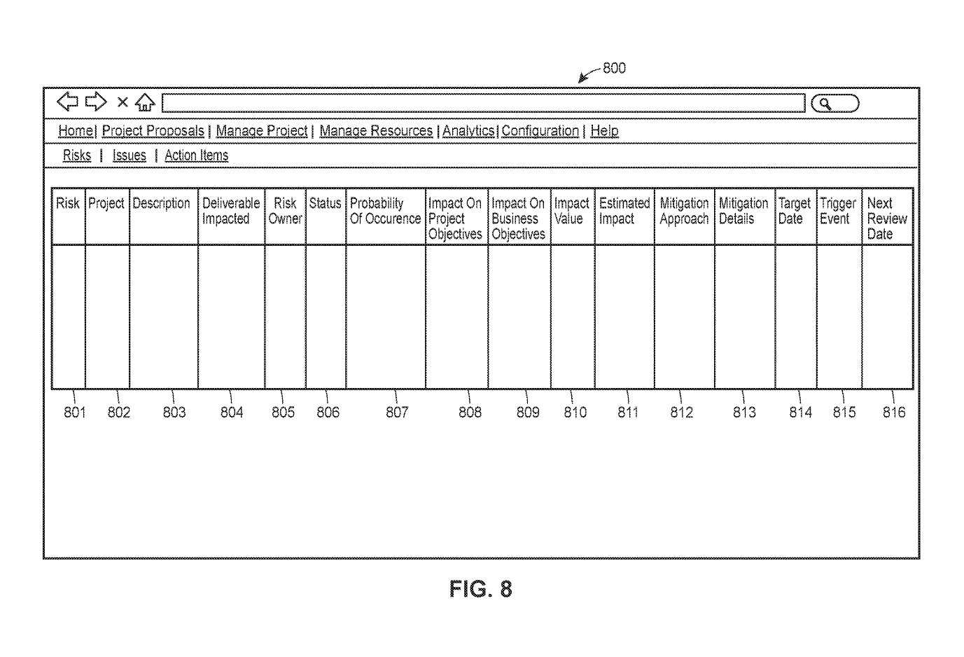

FIG. 8 illustrates a screenshot of an example workspace 800, which can be used to facilitate the process of identifying and creating plans or actions to deal with risks and issues. With reference to FIG. 4, the workspace 800 may be generated by the project management engine 406 and stored as part of the workspaces 420. A user can interact with the workspace 800 to configure any number of risk control plans, issue resolution plans, and/or action items. As shown in FIG. 8, the user can define a risk control plan by specifying information in columns 801-816. More particularly, the user can begin by defining a risk in a risk number column 801, a project that the risk is associated with in a project column 802, a description of the risk in a description column 803, a deliverable associated with the risk in a deliverable impacted column 804, information identifying the user in a risk owner column 805, and a risk status in a status column 806. The user can also specify a probability of occurrence for the risk in a probability column 807, and various impacts of the risk, such as impact on project objectives, impact on business objectives, impact value and estimated impact, in columns 808-811, respectively. The user can then describe the risk control plan to deal with the risk by specifying approaches to mitigation, mitigation details, a target date to complete the risk control plan, a trigger event, and a next review date for the risk control plan in columns 812-816, respectively.

The project management engine 406 may treat a risk control plan, issue resolution plan, and/or action item in the same way as a deliverable. In other words, the project management engine 406 executes the time entry module 406A to track user inputs (e.g., logged time) for each plan or action. The project management engine 406 then executes the status module 406B to determine and monitor the progress being made and the current status of each plan or action based on the user supplied inputs. Further, similar to deliverables, workers may be allocated to work on a particular plan or action. Workers working on a deliverable may add risk control plans, issue resolution plans and/or action items as needed, and project managers in charge may review and approve the added plans or actions as required. Moreover, in some implementations, the project management engine 406 may allow the users to create and track additional activities (e.g., administrative activities, one-time tasks, etc.) that provide support related to a project or deliverables in the project.

In general, any type of work assignment (e.g., deliverables, risk control plans, issue resolution plans, action items, support tasks, etc.) can be tracked and monitored by the project management engine 406. In this regard, the project management engine 406 enables the users (e.g., workers, project managers, administrators, etc.) to easily view and understand the deadlines for a project or independent tasks, how much time or work has already been spent on the project or tasks, the current status of the project or tasks, as well as other key metrics related to the execution and completion of the project or tasks.

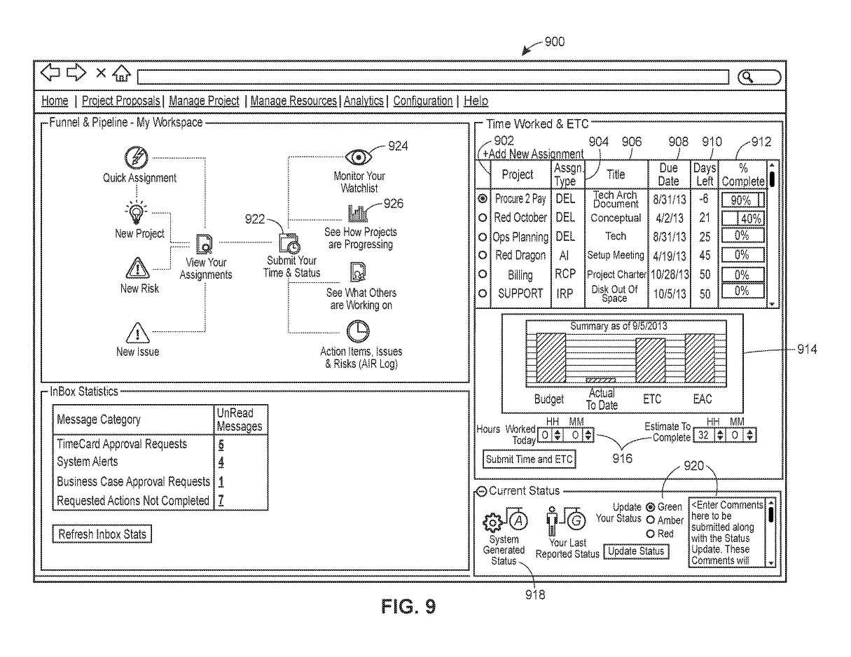

FIG. 9 illustrates a screenshot of an example workspace 900, which can be used to facilitate the process of executing, monitoring and managing a project. With reference to FIG. 4, the workspace 900 may be generated by the project management engine 406, and stored as part of the workspaces 420. Users, such as workers or project managers, may interact with the workspace 900 to perform various activities such as selecting an assignment associated with a project (e.g., a deliverable, a risk control plan, an issue resolution plan, or an action item), logging time for the selected assignment, reviewing the progress being made on the selected assignment, reviewing the current status of the selected assignment, etc.

In FIG. 9, columns 902-912 show respectively the project associated with a selected assignment, the type of assignment, the title of the selected assignment, the due date of the selected assignment, the number of days left until the due date, and the calculated percentage of completion for the selected assignment. For the selected assignment shown in the column 902, the budgeted time, the actual working time, the ETC time and the EAC time associated with the selected assignment are displayed as bar graphs in box 914. The workspace 900 also shows input boxes 916 that allow the users to submit the actual working time and the ETC time for the selected assignment. Still further, the workspace 900 includes a current status indicator 918 that indicates the determined current status of the selected assignment, as well as input fields 920 that enable the users to manually update the current status of the selected assignment.

Additionally, FIG. 9 shows different icons or links, which when selected, allow the users to view or access other workspaces to perform further activities associated with executing, monitoring and managing a project.

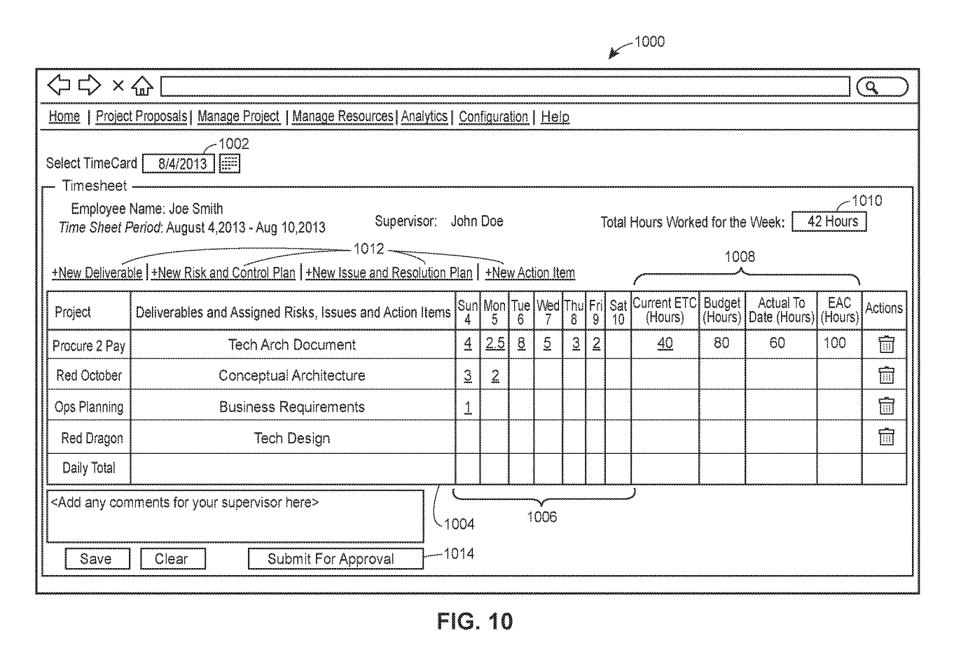

For example, selecting a link 922 in FIG. 9 allows a user to enter, edit and submit time for any assignment that the user has worked on. FIG. 10 illustrates a screenshot of an example workspace 1000, which can be used to facilitate the process of entering, editing and submitting time. With reference to FIG. 4, the workspace 1000 may be generated by the project management engine 406, and stored as part of the workspaces 420. The user can interact with the workspace 1000 to select a time period 1002 (e.g., a specific week) for time entry purposes. Once the time period 1002 is selected, the user can enter and/or edit time on various assignments assigned to the user (e.g., deliverables, risk control plans, issue resolution plans, etc.). As shown in FIG. 10, for each assignment in column 1004, the user can enter the actual number of hours spent working on the assignment each day in columns 1006. Based on the time entered in the columns 1006, the workspace 1000 may display the ETC time, the budgeted time, the actual working time, and the EAC time for each assignment in columns 1008. The workspace 1000 can also show the total number of hours worked for all assignments during the selected time period in box 1010. Further, the workspace 1000 may allow the user to add new assignments, as desired or needed, for the selected time period through buttons 1012. After the user has finished entering or editing time for the selected time period, the user can submit the time for approval from his or her supervisor through a submit button 1014.

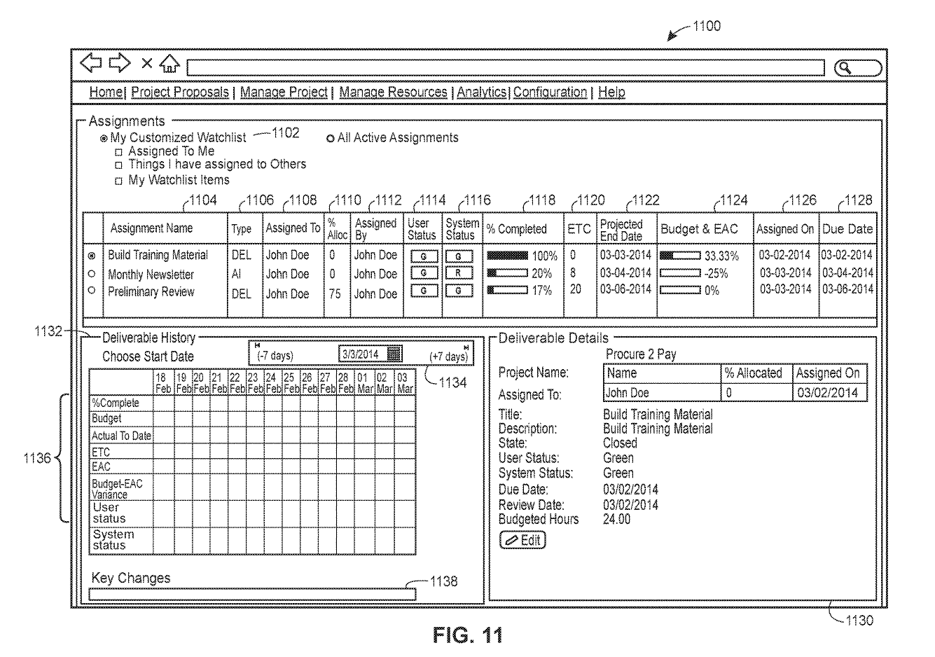

As another example, selecting a link 924 in FIG. 9 allows a user to manage a “watchlist” of assignments. FIG. 11 illustrates a screenshot of an example workspace 1100, which can be used to facilitate the process of managing the “watchlist.” With reference to FIG. 4, the workspace 1100 may be generated by the project management engine 406, and stored as part of the workspaces 420. The user can interact with the workspace 1100 to customize the contents of the “watchlist” through buttons 1102. For example, the user may select to view all active assignments, or a particular set of assignments assigned to or by the user. Once customized, the assignments are displayed in columns 1104-1128. In particular, the descriptions for each assignment are shown in an assignment name column 1104, an assignment type column 1106, an assigned to column 1108, a percentage of allocation column 1110, and an assigned by column 1112, respectively. Further, the current status of each assignment is shown in a user status column 1114 and a system status column 1116. The user status column 1114 indicates the current status of the assignment as determined by the user, while the system status column 1116 indicates the current status of the assignment as determined by the system (e.g., the status module 406B of the project management engine 406 in FIG. 4). Moreover, the progress being made on each assignment is shown in a percentage complete column 1118. Other parameters or metrics associated with each assignment are shown in an ETC column 1120, a projected end date column 1122, a budget to EAC variance column 1124, a planned start date (or assigned on) column 1126, and a planned end date (or due date) column 1128, respectively.

Further, the system or a project manager can utilize the workspace 1100 to quickly determine the work performance of particular workers. For example, the assigned to column 1108 displays the worker assigned to work on a particular assignment. The current status and progress being made on the particular assignment are indicated in respective entries in the columns 1114-1128. If the system or project manager determines that the assigned worker is not performing the work in a timely manner, the system or project manager may “virtually poke” the worker to inquire about the situation. In an example implementation, a “virtual poke” may be in the form of email that is sent out to the worker to request an explanation and an update on the progress of the assignment.

The user may also select an assignment in the column 1104 to view further details of the assignment. As such, for a selected assignment, the workspace 1100 may display a summary 1130 which provides a brief overview of the selected assignment including the description and current status, and a history 1132 which provides a complete history of the selected assignment. For example, the user may select a time period 1134 (e.g., 10 days) to view all relevant historical information associated with the selected assignment. Accordingly, the history 1132 may display in rows 1136 the percentage complete, the budget, the actual working time, the ETC time, the EAC time, the budget to EAC variance, the user indicated current status, and the system generated current status for the selected assignment defined for each day in the time period 1134. Further, the history 1132 may display important changes that have occurred during the time period 1134 in a key changes field 1138. For example, the key changes field 1138 may list changes that were made to the budget or the planned end date, as well as changes in the current status of the selected assignment as a result of system updates or updates made by the user. By providing a historical view of the selected assignment, the user can quickly determine the overall progress of the assignment and diagnose the root cause if current progress is not aligned with the planned progress.

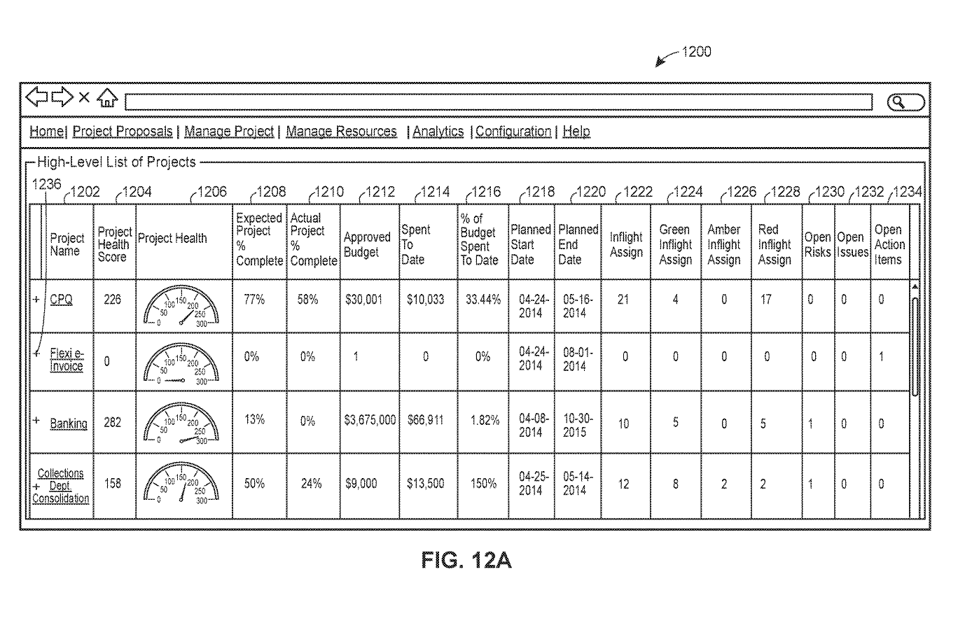

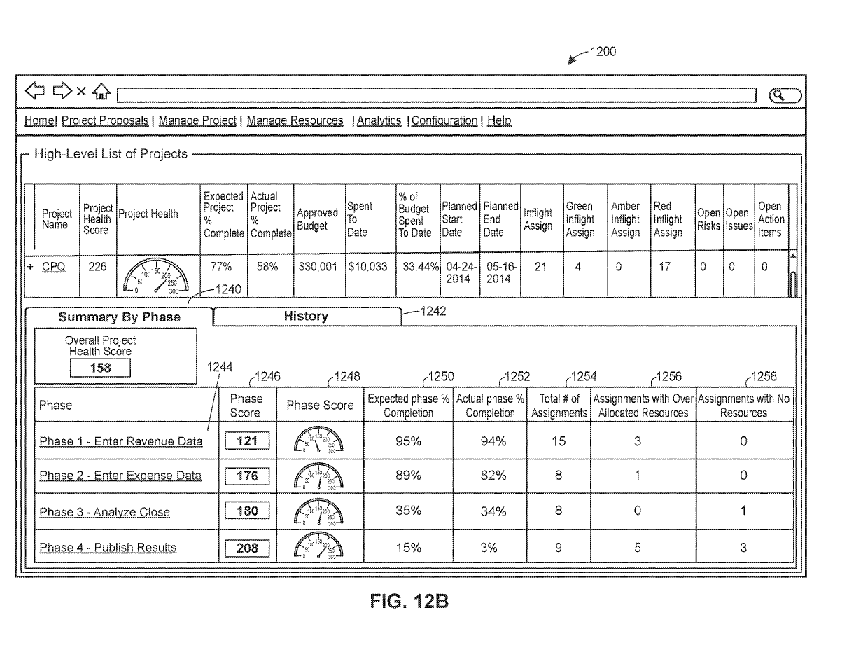

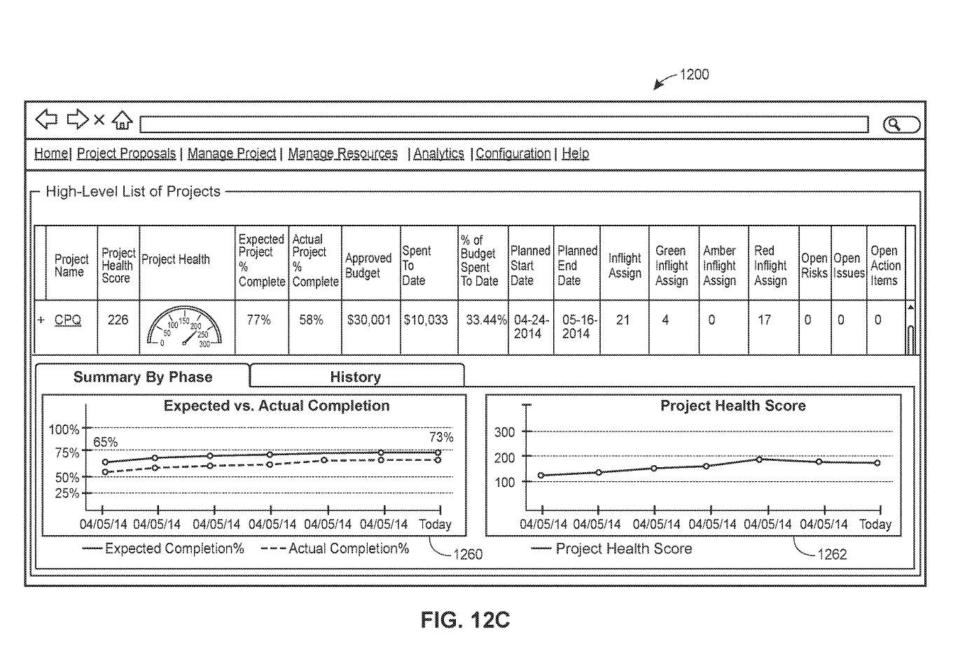

As a further example, selecting a link 926 in FIG. 9 allows a user to manage a high-level list of projects. FIGS. 12A-12C illustrate screenshots of an example workspace 1200, which can be used to facilitate the process of managing the high-level list. With reference to FIG. 4, the workspace 1200 may be generated by the project management engine 406, and stored as part of the workspaces 420.

FIG. 12A shows critical high-level information regarding individual projects. As such, the name of each project is shown in a project name column 1202. The current status of each project is indicated in columns 1204 and 1206. In particular, the column 1204 shows an overall project health score associated with each project, while the column 1206 shows a radial gauge that visually depicts the overall project health score. The overall project health score is described in more detail below. The progress being made on each project is indicated in an expected project percentage complete column 1208 and an actual project percentage complete column 1210. Monetary metrics associated with each project are also shown in an approved budget column 1212, an actual amount of money spent to date column 1214, and a percentage of budget spent to date column 1216. Further, planned start and end dates for each project are shown in columns 1218 and 1220, respectively. The number of inflight assignments for each project is shown in an inflight assignment column 1222. An inflight assignment may be defined as an assignment that have a planned start date as of the current date or earlier and that is not 100% complete. The number of inflight assignments is further classified based on the current status of the inflight assignments. For example, the number of inflight assignments for which the current status is acceptable is listed in a green inflight assignment column 1224. The number of inflight assignments for which the current status shows a slight setback is listed in an amber inflight assignment column 1226. Likewise, the number of inflight assignments for which the current status shows a severe setback is listed in a red inflight assignment column 1228. Moreover, the number of identified risks, issues and/or action items associated with each project are listed in an open risks column 1230, an open issues column 1232, and an open action items column 1234.

The user may view further details of each project by executing an icon 1236 in FIG. 12A to select a particular project. Once executed, the workspace 1200 displays an overview for the selected project. For example, FIG. 12B shows a summary by project phase 1240, while FIG. 12C shows a project history 1242.

In FIG. 12B, the summary by project phase 1240 lists all the phases in the selected project in a phase column 1244 as well as the current status of each phase in columns 1246 and 1248. In particular, the column 1246 shows a phase health score associated with each phase, while the column 1248 shows a radial gauge that visually depicts the phase health score. Further, the progress being made on each phase in the selected project is indicated in an expected phase percentage complete column 1250 and an actual phase percentage complete column 1252. The number of assignments for each phase is shown in a total number of assignments column 1254. Additionally, the number of assignments with over-allocated resources in each phase is shown in a column 1256, and the number of assignments with no resources in each phase is shown in a column 1258.

In FIG. 12C, the project history 1242 shows historical data or trend on the expected project percentage complete and the actual project percentage complete in a box 1260. The project history 1242 also shows historical data or trend on the overall project health score in a box 1262. These historical data allows the user to easily view and understand the progress being made on the selected project.

The overall project health score of a project is calculated based on a weighted average of health scores for individual deliverables in the project. More particularly, each deliverable in the project is assigned a weight factor. As an example, the weight factor for each deliverable or task may be determined by dividing the budget or EAC by the total budget or EAC of the project. Next, the weight factor for each deliverable or task is multiplied by a health score associated with each deliverable or task in order to produce a weighted health score for each deliverable or task. All weighted health scores are then summed to determine the overall project health score.

In an example implementation, a health score may be on a scale of 100 to 300, with 100 being the best score and 300 being the most alarming or worst score. The weighted average calculation is important because not all deliverables are equal. Relative importance of a deliverable may be based on various indicators such as labor efforts or labor costs. To better understand this, consider the following example where a project (with a budget of 100 hours) comprises three deliverables: (i) deliverable A (with a budgeted effort of 60 hours and a weight factor of 60/100=0.6); (ii) deliverable B (with a budgeted effort of 30 hours and a weight factor of 30/100=0.3); and (iii) deliverable C (with a budgeted effort of 10 hours and a weight factor of 10/100=0.1). Deliverable A has the highest weight factor. Thus, if deliverable A suffers a setback, then the impact to the project will be more severe than if deliverable B or C suffers a setback. This is illustrated in the following three scenarios.

In scenario 1, deliverable A incurs a setback which causes the status of deliverable A to turn “Red.” On the other hand, deliverables B and C did not incur any setback and thus their statuses are indicated as “Green.” Accordingly, the health score for deliverable A is 300 because of the “Red” status, while the health scores for deliverables B and C are 100 because of the “Green” status. The weighted average calculation is carried out by multiplying the health score for each deliverable with the weight factor associated with each deliverable. The results are then added up to produce the overall project health score. As indicated in scenario 1, the overall project health score is 220.

Scenario 1

| | | | | Weighted |
|---|---|---|---|---|
| | | Individual | Weighted Score | Health |
| Deliverable | Status | Health Score | Calculation | Score |
| deliverable A | Red | 300 | =300 * 0.6 | 180 |
| deliverable B | Green | 100 | =100 * 0.3 | 30 |
| deliverable C | Green | 100 | =100 * 0.1 | 10 |
| Overall Project | Amber | N/A | =180 + 30 + 10 | 220 |

In scenario 2, deliverable B incurs a setback which causes the status of deliverable B to turn “Red.” However, deliverables A and C have not incurred any setback and their statuses remain “Green.” Thus, according to the weighted average calculation, the overall project health score in scenario 2 is 160.

Scenario 2

| | | Individual | Weighted | Weighted |
|---|---|---|---|---|
| | | Health | Score | Health |
| Deliverable | Status | Score | Calculation | Score |
| deliverable A | Green | 100 | =100 * 0.6 | 60 |
| deliverable B | Red | 300 | =300 * 0.3 | 90 |
| deliverable C | Green | 100 | =100 * 0.1 | 10 |
| Overall Project | Light Amber | N/A | =180 + 30 + 10 | 160 |

In scenario 3, deliverable C incurs a setback which causes the status of deliverable C to turn “Red”, while deliverables A and B have not incurred any setback and their statuses remain “Green.” As a result, from the weighted average calculation, the overall project health score for scenario 3 is 120.

Scenario 3

| | | | | Weighted |
|---|---|---|---|---|
| | | Individual | Weighted Score | Health |
| Deliverable | Status | Health Score | Calculation | Score |
| deliverable A | Green | 100 | =100 * 0.6 | 60 |
| deliverable B | Green | 100 | =100 * 0.3 | 30 |
| deliverable C | Red | 300 | =300 * 0.1 | 30 |
| Overall Project | Greenish- | N/A | =180 + 30 + 10 | 120 |
| | Amber | | | |

As shown in the above three scenarios, when deliverable A suffers a setback, the overall project health score becomes the worst. However, when deliverables B and C suffer setbacks, the overall project health score is much better. This indicates that deliverable A has a greater impact on the progress or outcome of the project than either deliverables B or C.

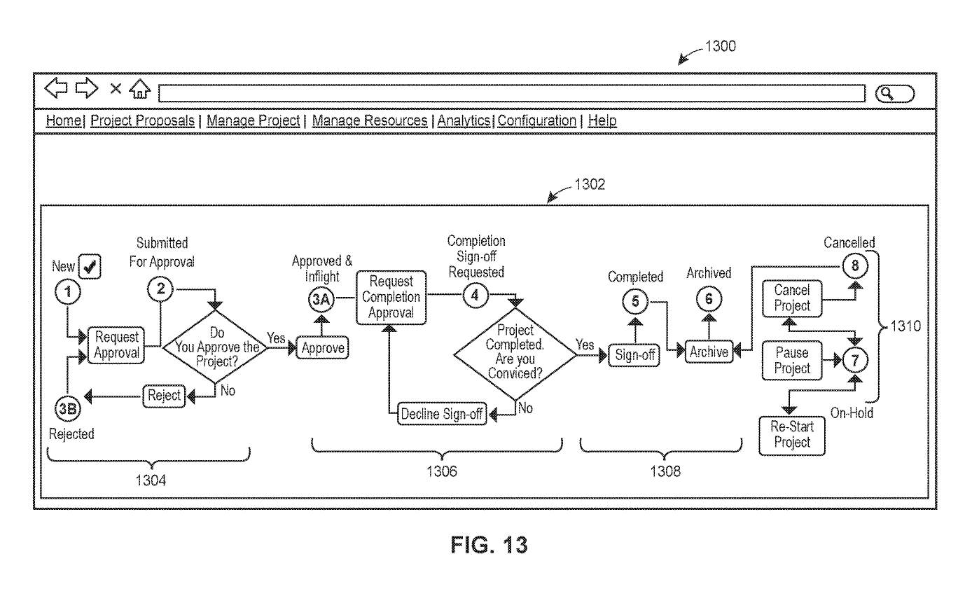

When interacting with the workspace 1200, the user can also select a project in the column 1202 to review a project governance flowchart associated with the project. FIG. 13 illustrates a screenshot of an example workspace 1300, which can be used to facilitate the process of reviewing the project governance flowchart. With reference to FIG. 4, the workspace 1300 may be generated by the project management engine 406, and stored as part of the workspaces 420. In an implementation, the user may activate the workspace 1300 by selecting a project listed in the column 1202 of FIG. 12. FIG. 13 shows a typical project governance flowchart 1302, which depicts the different stages of a project lifecycle such as an approval stage, an execution stage and a post-completion stage. The progress of the project is tracked and displayed by the flowchart 1302 as the project moves from one stage to another. In addition to visually displaying the state of the project lifecycle, the flowchart 1302 provides a visual workspace for the users to move the project along the lifecycle by clicking on the respective workflow buttons to request action as well for those users with authority to approve or reject those requests. This provides a system of enforced governance that is generally not available in current or other project management tools. For example, the users are not allowed to track time unless a project has been approved.

Generally, the flowchart 1302 can be divided into three sections. The flowchart 1302 begins with an approval section 1304, which shows a flow of events related to the project approval stage. For example, the flowchart 1302 may indicate whether a project is approved or rejected in the approval section 1304. If the project is approved, the flowchart 1302 continues to an execution section 1306, which shows a flow of events related to the project execution stage. For example, the flowchart 1302 may indicate whether the project is being executed or if the project has been completed in the execution section 1306. The flowchart 1302 terminates with a post-completion section 1308, which shows a flow of events related to the project post-completion stage. For example, the flowchart 1302 may indicate whether the completed project has been archived in the post-completion section 1308. Furthermore, the flowchart 1302 also includes a decision section 1310, which shows different high-level decisions that the user can make to affect the project. The decision section 1310 is connected to the post-completion section 1308, and may indicate whether the project has been canceled, paused or restarted.

Referring once again to FIG. 4, generally speaking, users can further interact with the application 402, via the workspaces 420, to perform portfolio planning and management. To carry out this function, the application 402 executes a portfolio management engine 408, which includes a project evaluation module 408A, a financial analysis module 408B, and a resource utilization module 408C.

Project portfolio planning and management generally involves analyzing and organizing a group of active and/or proposed projects. In an implementation, the portfolio management engine 408 executes the project evaluation module 408A to analyze proposed and/or active projects based on various business valuation criteria. In particular, to evaluate a proposed project, the project evaluation module 408A first queries the users to enter a set of information related to the proposed project. Based on the gathered information, the project evaluation module 408A then computes an overall score to rate the feasibility of the proposed project.

In an example implementation, the project evaluation module 408A queries the users to enter four sets of information. The first set entails descriptive information including a project title, project objectives (e.g., increase revenue, increase market competitive, research and development, etc.), a desired project completion date, and high-level cost benefit information such as internal or external labor estimates (essentially one-time costs or ongoing added expenses), total benefits over a 5 year period, or other costs.

The second set entails information regarding how the proposed project fits with the strategic goals of the business. For example, the purpose of the proposed project may be related to increasing the total revenue of the business by 5% annually, or raising the customer retention rate from 95% to 98%.

The third set entails information about the proposed project type (e.g., a project to develop new software, a project to build a new data center, a project to enhance a business process, etc.). The third set of information also describes the project asset that will be generated by the proposed project.

The fourth set entails information related to the business value of the proposed project such as benefits (e.g., additional revenue or cost savings delivered by the proposed project), one-time costs (e.g., initial cost to start the proposed project), and annual operating expenses (e.g., additional costs to be spent annually in order to achieve the benefits). For the fourth set of information, the users can define individual items for each of the benefits, one-time costs, and annual operating expenses from scratch. Alternatively or additionally, depending on the proposed project type, the users can select a standard project template associated with project type, which includes a list of pre-defined items for each of the benefits, one-time costs, and annual operating expenses. Once gathered, the project evaluation module 408A may store the four sets of information as part of the project evaluation data 418A in the database 412.

From the fourth set of information, the project evaluation module 408A may derive a cash flow for the proposed project. Generally, a cash flow statement indicates whether cash will be generated, and thus provides a mechanism to evaluate whether a proposed project is worth doing. To determine the cash flow, the project evaluation module 408A invokes the financial analysis module 408B to calculate cash flow parameters such as net cash flow, payback period, net present value (NPV), and internal rate of return (IRR).

For example, the financial analysis module 408B may access the project evaluation data 418A to determine the benefits, one-time costs, and annual operating expenses associated with a proposed project. The financial analysis module 408B may then compute the net cash flow by subtracting the costs from the benefits.

As another example, the financial analysis module 408B may access the project evaluation data 418A to compute the NPV, which represents the present value of the net cash flow. To determine the NPV, the financial analysis module 408B may use the following formula:

$$N P V = \frac{{FV}_{1}}{{( 1 + i )}^{1}} + \frac{{FV}_{2}}{{( 1 + i )}^{2}} + \frac{{FV}_{3}}{{( 1 + i )}^{3}} + … + \frac{{FV}_{N}}{{( 1 + i )}^{N}} ,$$

where FV represents the projected cash flow for each time period, i represents the discount rate, and N represents the time periods (e.g., in years).

As a further example, the financial analysis module 408B may access the project evaluation data 418A to compute the IRR, which represents the actual rate of return provided by the propose project. To calculate the IRR, the financial analysis module 408B determines a value for the discount rate i which makes the NPV value equal to zero.

The calculated cash flow parameters, along with other parameters derived from user-entered information (e.g., revenue retention, strategic alignment, confidence in benefits, confidence in costs, achievability, compliance risk mitigation, and technology risk mitigation), comprise a set of scoring metrics that the project evaluation module 408A uses to determine an overall score for the proposed project. In some implementations, the project evaluation module 408A may only use a subset of the set of scoring metrics. In any event, by evaluating the set of scoring metrics, the project evaluation module 408A determines the overall score that indicates the feasibility of the proposed project. The overall score may be, for example, a number, a percentage, a letter grade, etc. Accordingly, by examining the overall score, project managers and other business leaders can quickly determine and select the most feasible project to invest. Along with the scoring metrics, the project evaluation module 108A may also use various data to determine a confidence factor for the numbers being provided. This confidence factor is used to provide a realistic means to evaluate the value of the project, and to filter out unrealistic project proposals.

To perform evaluation on approved or active projects, the project evaluation module 408A determines the business impact of each active project. To do so, the project evaluation module 408A invokes the financial analysis module 408B, which in turn may access the project evaluation data 418A to calculate cash flow and income statement parameters associated with each active project. Based on these calculated parameters, the project evaluation module 408A can rank each active project in terms of business impact such as net cash flow or benefits, net income, projected revenue, depreciation, etc. Accordingly, based on the ranking of active projects, project managers and other business leaders can quickly understand the impact that each active project has on the business.

Furthermore, as part of the portfolio planning and management, the portfolio management engine 408 can execute the resource utilization module 408C and retrieve the project resource data 418B in the database 412 to perform resource management. The project resource data 418B may specify information regarding personnel, equipment, facilities, etc. For example, the resource utilization module 408C may access the project resource data 418B to assign workers to work on different deliverables in a project based on the workers' available skill sets and current utilization.

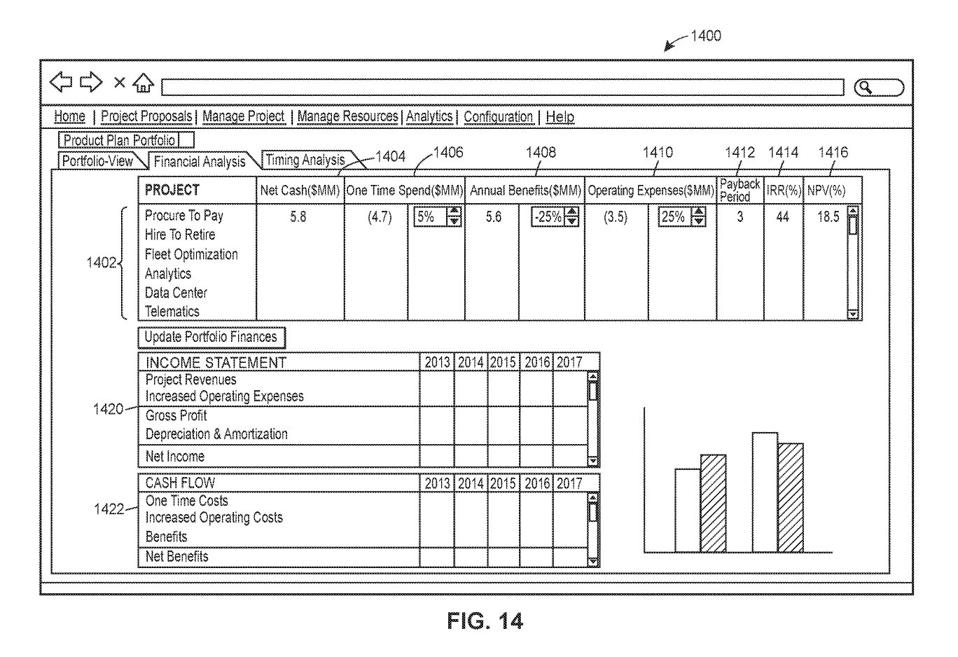

FIG. 14 shows a screenshot of an example workspace 1400, which illustrates how multiple projects are evaluated and organized in a project portfolio. With reference to FIG. 4, the workspace 1400 may be generated by the portfolio management engine 408, and stored as one of the workspaces 420. The workspace 1400 shows multiple projects 1402 in a project portfolio. The workspace 1400 also shows various financial metrics associated with each of the projects 1402, such as net cash 1404, one-time costs 1406, annual benefits or revenue 1408, annual operating expenses 1410, payback period 1412, IRR 1414, and NPV 1416. Based on the financial metrics 1404-1416, the workspace 1400 may rank the projects 1402 to indicate the relative business impact of each project. Further, for a selected project in the project portfolio, the workspace 1400 enables a user to enter or modify cash flow and income statement parameters through input boxes 1420 and 1422, respectively. In doing so, the user can continuously update the financial status of each of the projects 1402.

The following additional considerations apply to the foregoing discussion. Throughout this specification, plural instances may implement functions, routines, or operations structures described as a single instance. Although individual functions and instructions of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of functions, components, modules, blocks, or mechanisms. Functions may constitute either software modules (e.g., non-transitory code stored on a tangible machine-readable storage medium) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain functions. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example functions and methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or functions described herein may be at least partially processor-implemented. For example, at least some of the functions of a method may be performed by one or processors or processor-implemented hardware modules. The performance of certain of the functions may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the functions may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data and data structures stored as bits or binary digital signals within a machine memory (e.g., a computer memory). These algorithms or symbolic representations are examples of techniques used by those of ordinary skill in the data processing arts to convey the substance of their work to others skilled in the art. As used herein, a “function” or a “routine” is a self-consistent sequence of operations or similar processing leading to a desired result. In this context, functions, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a function, process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments or implementations of a project management system for purposes of illustration only. One of ordinary skill in the art will readily recognize from the foregoing discussion that alternative embodiments or implementations of the structures and methods illustrated herein may be employed without departing from the principles described herein.

Upon reading this disclosure, those of skill in the art will appreciate still additional alternative structural and functional designs for a project management system and a method for planning and managing projects and/or independent tasks can be used as well or instead. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A system for planning and managing a project implemented on a plurality of computers connected by a network that allows a plurality of workers using the connected network of computers to input real-time information on work being performed on the project and a plurality of managers using the connected network of computers to view real-time progress of the project, the system comprising:
a project management database; and
a project management server configured to:
(i) define, via at least one of the connected network of computers, a deliverable associated with the project, the deliverable specifying an amount of work that needs to be performed to complete the project;
(ii) assign, via at least one of the connected network of computers, a budget, a planned start date, and a planned end date for the deliverable;
(iii) allocate, via at least one of the connected network of computers, one or more of the plurality of workers to perform the amount of work on the deliverable including setting a maximum number of hours per day for the one or more of the plurality of workers to work on the deliverable;
(iv) determine, via at least one of the connected network of computers, an available capacity for the one or more of the plurality of workers, wherein the available capacity is determined by: (a) a reserved capacity based on a first number of hours per day that the one or more of the plurality of workers are scheduled to work on the deliverable, the first number of hours being equal to or less than the maximum number of hours; and (b) a free capacity if the first number of hours is less than the maximum number of hours, the free capacity being based on a second number of hours per day that the one or more of the plurality of workers may be able to work on the deliverable such that the sum of the first and second number of hours does not exceed the maximum number of hours;
(v) perform the following to continuously monitor a progress made on the project:
(i) periodically receive, via the connected network of computers, an indication of an actual amount of work performed on the deliverable by the one or more of the plurality of workers;
(ii) periodically receive, via the connected network of computers, an indication of an estimate to completion (ETC) for the deliverable, the indication of the ETC being associated with the one or more of the plurality of workers' estimation on how much more work that the one or more of the plurality of workers must perform in order to complete the deliverable and being periodically updated to indicate a difference between, as the indication of the actual amount is periodically received, (a) updated values associated with a sum of each of the one or more of the plurality of workers' total reserved capacity until the planned end date, and (b) updated values associated with a sum of the actual amount of work performed on the deliverable;
(vi) store the received indication of the actual amount of work performed on the deliverable by the one or more of the plurality of workers and the indication of the ETC in the project management database;
(vii) after the one or more of the plurality of workers have started to perform work on the deliverable but before the one or more of the plurality of workers have finished performing work on the deliverable, calculate, via at least one of the connected network of computers, an estimate at completion (EAC) for the deliverable based on summing the indication of the actual amount of work performed on the deliverable by the one or more of the plurality of workers and the indication of the ETC for the deliverable;
(viii) after the one or more of the plurality of workers have started to perform work on the deliverable but before the one or more of the plurality of workers have finished performing work on the deliverable, calculate, via at least one of the connected network of computers, a projected end date for the deliverable based on comparing the available capacity for the one or more of the plurality of workers and the indication of the ETC for the deliverable;
(ix) after the one or more of the plurality of workers have started to perform work on the deliverable but before the one or more of the plurality of workers have finished performing work on the deliverable, calculate, via at least one of the connected network of computers, a status for the deliverable based on one or more of: (a) a comparison between the budget and the EAC; (b) a comparison between the projected end date and the planned end date; or (c) a comparison between the allocation of an actual number of hours and the set maximum number of hours per day for the one or more of the plurality of workers to work on the deliverable between the planned start date and the planned end date; and
(x) store the calculated status for the deliverable in the project management database; and
(xi) display, via at least one of the connected network of computers, the status for the deliverable to one or more of at least one of the plurality of workers or at least one of the plurality of managers.

2. The system of claim 1, wherein the project management server is further configured to:
after the one or more of the plurality of workers have started to perform work on the deliverable but before the one or more of the plurality of workers have finished performing work on the deliverable, calculate, via at least one of the connected network of computers, a percentage of completion for the deliverable based on dividing the indication of the actual amount of work performed by the one or more of the plurality of workers and the EAC for the deliverable;
store the calculated percentage of completion for the deliverable in the project management database; and
display, via the connected network of computers, the percentage of completion for the deliverable to the one or more of the at least one of the plurality of workers or the at least one of the plurality of managers.

3. The system of claim 1, wherein the status includes a current status and a historical status for the deliverable.

4. A computer-implemented method for planning and managing a project implemented on a plurality of computers connected by a network that allows a plurality of workers using the connected network of computers to input real-time information on work being performed on the project and a plurality of managers using the connected network of computers to view real-time progress of the project, the method comprising:
defining, via at least one of the connected network of computers, a deliverable associated with the project, the deliverable specifying an amount of work that needs to be performed to complete the project;
assigning, via at least one of the connected network of computers, a budget, a planned start date, and a planned end date for the deliverable;
allocating, via at least one of the connected network of computers, one or more of the plurality of workers to perform the amount of work on the deliverable including setting a maximum number of hours per day for the one or more of the plurality of workers to work on the deliverable;
determining, via at least one of the connected network of computers, an available capacity for the one or more of the plurality of workers, wherein the available capacity is determined by: (i) a reserved capacity based on a first number of hours per day that the one or more of the plurality of workers are scheduled to work on the deliverable, the first number of hours being equal to or less than the maximum number of hours; and (ii) a free capacity if the first number of hours is less than the maximum number of hours, the free capacity being based on a second number of hours per day that the one or more of the plurality of workers may be able to work on the deliverable such that the sum of the first and second number of hours does not exceed the maximum number of hours;
continuously monitoring a progress made on the project by:
periodically receiving, via the connected network of computers, an indication of an actual amount of work performed on the deliverable by the one or more of the plurality of workers;
periodically receiving, via the connected network of computers, an indication of an estimate to completion (ETC) for the deliverable, the indication of the ETC being associated with the one or more of the plurality of workers' estimation on how much more work that the one or more of the plurality of workers must perform in order to complete the deliverable and being periodically updated to indicate a difference between, as the indication of the actual amount is periodically received, (i) updated values associated with a sum of each of the one or more of the plurality of workers' total reserved capacity until the planned end date, and (ii) updated values associated with a sum of the actual amount of work performed on the deliverable;
after the one or more of the plurality of workers have started to perform work on the deliverable but before the one or more of the plurality of workers have finished performing work on the deliverable, calculating, via at least one of the connected network of computers, an estimate at completion (EAC) for the deliverable based on summing the indication of the actual amount of work performed on the deliverable by the one or more of the plurality of workers and the indication of the ETC for the deliverable;
after the one or more of the plurality of workers have started to perform work on the deliverable but before the one or more of the plurality of workers have finished performing work on the deliverable, calculating, via at least one of the connected network of computers, a projected end date for the deliverable based on comparing the available capacity for the one or more of the plurality of workers and the indication of the ETC for the deliverable; and
after the one or more of the plurality of workers have started to perform work on the deliverable but before the one or more of the plurality of workers have finished performing work on the deliverable, calculating, via at least one of the connected network of computers, a status for the deliverable based on one or more of: (i) a comparison between the budget and the EAC; (ii) a comparison between the projected end date and the planned end date; or (iii) a comparison between the allocation of an actual number of hours and the set maximum number of hours per day for the one or more of the plurality of workers to work on the deliverable between the planned start date and the planned end date; and
displaying, via at least one of the connected network of computers, the status for the deliverable to one or more of at least one of the plurality of workers or at least one of the plurality of managers.

5. The computer-implemented method of claim 4, further comprising:
after the one or more of the plurality of workers have started to perform work on the deliverable but before the one or more of the plurality of workers have finished performing work on the deliverable, calculating, via at least one of the connected network of computers, a percentage of completion for the deliverable based on dividing the indication of the actual amount of work performed by the one or more of the plurality of workers and the EAC for the deliverable; and
displaying, via at least one of the connected network of computers, the percentage of completion for the deliverable to the one or more of the at least one of the plurality of workers or the at least one of the plurality of managers.

6. The computer-implemented method of claim 4, wherein the status includes a current status for the deliverable.

7. The computer-implemented method of claim 4, wherein the status includes a historical status for the deliverable.

8. The computer-implemented method of claim 4, wherein the status includes a current status and a historical status for the deliverable.

9. The computer-implemented method of claim 5, wherein the percentage includes an actual percentage and an expected percentage of completion for the deliverable.

10. The computer-implemented method of claim 4, wherein the reserved capacity is determined by multiplying the first number of hours per day that the one or more of the plurality of workers is scheduled to work on the deliverable by a number of days remaining until the planned end date, and the free capacity is determined by multiplying the second number of hours per day that the one or more of the plurality of workers may be able to work on the deliverable by the number of days remaining until the planned end date.

11. The computer-implemented method of claim 4, wherein calculating the projected end date based on comparing the available capacity for the one or more of the plurality of workers and the indication of the ETC for the deliverable includes determining the projected end date to be equal to the planned end date if the available capacity is greater than or equal to the ETC, or determining the projected end date to be greater than the planned end date if the available capacity is less than the ETC.

12. The computer-implemented method of claim 4, wherein calculating the status based on the comparison between the budget and the EAC or the comparison between the projected end date and the planned end date includes determining a percentage difference between the budget and the EAC, or a percentage difference between the projected end date and the planned end date.

13. The computer-implemented method of claim 12, wherein displaying the status includes displaying: (i) a first indication of the status if the percentage difference between the budget and the EAC or the percentage difference between the projected end date and the planned end date is within a first range of percentage values; (ii) a second indication of the status if the percentage difference between the budget and the EAC or the percentage difference between the projected end date and the planned end date is within a second range of percentage values; or (iii) a third indication of the status if the percentage difference between the budget and the EAC or the percentage difference between the projected end date and the planned end date is greater than a third percentage value.

14. The computer-implemented method of claim 4, further comprising:
determining, via at least one of the connected network of computers, a weight for each deliverable in the project;
determining, via at least one of the connected network of computers, a weighted health score for each deliverable in the project by multiplying the weight for each deliverable with a health score associated with each deliverable; and
determining, via at least one of the connected network of computers, an overall project health score for the project by summing each weighted health score.

15. The computer-implemented method of claim 4, wherein calculating the status based on the comparison between the allocation of the actual number of hours and the set maximum number of hours per day for the one or more of the plurality of workers to work on the deliverable includes determining a percentage difference between the allocation of the actual number of hours and the set maximum number of hours, and the displaying of the status is based on the percentage difference.

16. The computer-implemented method of claim 4, wherein the indication of the actual amount of work performed on the deliverable by the one or more of the plurality of workers is based on a number of hours spent on the deliverable.

17. The computer-implemented method of claim 4, wherein the indication of the actual amount of work performed on the deliverable by the one or more of the plurality of workers is based on an amount of cost incurred on the deliverable.

18. The computer-implemented method of claim 5, further comprising:
after the one or more of the plurality of workers have started to perform work on the deliverable but before the one or more of the plurality of workers have finished performing work on the deliverable, calculating, via at least one of the connected network of computers, a percentage of completion for an asset associated with the project based on the percentage of completion for the deliverable, the asset specifying a desired outcome that is produced when the project is completed; and
displaying, via at least one of the connected network of computers, the percentage of completion for the asset to the one or more of the at least one of the plurality of workers or the at least one of the plurality of managers.

19. The computer-implemented method of claim 4, wherein calculating the status for the deliverable is further based on one or more of a number of risks and issues associated with the deliverable, or severity of the risks and issues associated with the deliverable.

20. A non-transitory computer-readable storage medium including computer-readable instructions to be executed on one or more processors of a system for planning and managing a project implemented on a plurality of computers connected by a network that allows a plurality of workers using the connected network of computers to input real-time information on work being performed on the project and a plurality of managers using the connected network of computers to view real-time progress of the project, the instructions when executed causing the one or more processors to:
define, via at least one of the connected network of computers, a deliverable associated with the project, the deliverable specifying an amount of work that needs to be performed to complete the project;
assign, via at least one of the connected network of computers, a budget, a planned start date, and a planned end date for the deliverable;
allocate, via at least one of the connected network of computers, one or more of the plurality of workers to perform the amount of work on the deliverable including setting a maximum number of hours per day for the one or more of the plurality of workers to work on the deliverable;
determine, via at least one of the connected network of computers, an available capacity for the one or more of the plurality of workers, wherein the available capacity is determined by: (i) a reserved capacity based on a first number of hours per day that the one or more of the plurality of workers are scheduled to work on the deliverable, the first number of hours being equal to or less than the maximum number of hours; and (ii) a free capacity if the first number of hours is less than the maximum number of hours, the free capacity being based on a second number of hours per day that the one or more of the plurality of workers may be able to work on the deliverable such that the sum of the first and second number of hours does not exceed the maximum number of hours;
perform the following to continuously monitor a progress made on the project:
(i) periodically receive, via the connected network of computers, an indication of an actual amount of work performed on the deliverable by the one or more of the plurality of workers;
(ii) periodically receive, via the connected network of computers, an indication of an estimate to completion (ETC) for the deliverable, the indication of the ETC being associated with the one or more of the plurality of workers' estimation on how much more work that the one or more of the plurality of workers must perform in order to complete the deliverable and being periodically updated to indicate a difference between, as the indication of the actual amount is periodically received, (a) updated values associated with a sum of each of the one or more of the plurality of workers' total reserved capacity until the planned end date, and (b) updated values associated with a sum of the actual amount of work performed on the deliverable;
(iii) after the one or more of the plurality of workers have started to perform work on the deliverable but before the one or more of the plurality of workers have finished performing work on the deliverable, calculate, via at least one of the connected network of computers, an estimate at completion (EAC) for the deliverable based on summing the indication of the actual amount of work performed on the deliverable by the one or more of the plurality of workers and the indication of the ETC for the deliverable;
(iv) after the one or more of the plurality of workers have started to perform work on the deliverable but before the one or more of the plurality of workers have finished performing work on the deliverable, calculate, via at least one of the connected network of computers, a projected end date for the deliverable based on comparing the available capacity for the one or more of plurality of workers and the indication of the ETC for the deliverable; and
(v) after the one or more of the plurality of workers have started to perform work on the deliverable but before the one or more of the plurality of workers have finished performing work on the deliverable, calculate, via at least one of the connected network of computers, a status for the deliverable based on one or more of: (i) a comparison between the budget and the EAC; (ii) a comparison between the projected end date and the planned end date; or (iii) a comparison between the allocation of an actual number of hours and the set maximum number of hours per day for the one or more of the plurality of workers to work on the deliverable between the planned start date and the planned end date; and
display, via at least one of the connected network of computers, the status for the deliverable to one or more of at least one of the plurality of workers or at least one of the plurality of managers.

21. The non-transitory computer-readable storage medium of claim 20, further including instructions that, when executed, cause the one or more processors to:
after the one or more of the plurality of workers have started to perform work on the deliverable but before the one or more of the plurality of workers have finished performing work on the deliverable, calculate, via at least one of the connected network of computers, a percentage of completion for the deliverable based on dividing the indication of the actual amount of work performed by the one or more of the plurality of workers and the EAC for the deliverable; and
display, via at least one of the connected network of computers, the percentage of completion for the deliverable to the one or more of the at least one of the plurality of workers or the at least one of the plurality of managers.

22. The non-transitory computer-readable storage medium of claim 20, wherein the status includes a current status for the deliverable.

23. The non-transitory computer-readable storage medium of claim 20, wherein the status includes a historical status for the deliverable.

24. The non-transitory computer-readable storage medium of claim 20, wherein the status includes a current status and a historical status.

25. The non-transitory computer-readable storage medium of claim 21, wherein the percentage includes an actual percentage and an expected percentage of completion for the deliverable.

26. The non-transitory computer-readable storage medium of claim 20, wherein the reserved capacity is determined by multiplying the first number of hours per day that the one or more of the plurality of workers is scheduled to work on the deliverable by a number of days remaining until the planned end date, and the free capacity is determined by multiplying the second number of hours per day that the one or more of the plurality of workers may be able to work on the deliverable by the number of days remaining until the planned end date.

27. The non-transitory computer-readable storage medium of claim 20, wherein calculating the projected end date based on comparing the available capacity for the one or more of the plurality of workers and the indication of the ETC for the deliverable includes determining the projected end date to be equal to the planned end date if the available capacity is greater than or equal to the ETC, or determining the projected end date to be greater than the planned end date if the available capacity is less than the ETC.

28. The non-transitory computer-readable storage medium of claim 20, wherein calculating the status based on the comparison between the budget and the EAC or the comparison between the projected end date and the planned end date includes determining a percentage difference between the budget and the EAC, or a percentage difference between the projected end date and the planned end date.

29. The non-transitory computer-readable storage medium of claim 20, wherein displaying the status includes displaying: (i) a first indication of the status if the percentage difference between the budget and the EAC or the percentage difference between the projected end date and the planned end date is within a first range of percentage values; (ii) a second indication of the status if the percentage difference between the budget and the EAC or the percentage difference between the projected end date and the planned end date is within a second range of percentage values; or (iii) a third indication of the status if the percentage difference between the budget and the EAC or the percentage difference between the projected end date and the planned end date is greater than a third percentage value.

30. The non-transitory computer-readable storage medium of claim 20, further including instructions that, when executed, cause the one or more processors to:
determine, via at least one of the connected network of computers, a weight for each deliverable in the project;
determine, via at least one of the connected network of computers, a weighted health score for each deliverable in the project by multiplying the weight for each deliverable with a health score associated with each deliverable; and
determine, via at least one of the connected network of computers, an overall project health score for the project by summing each weighted health score.
